(19) United States
(12) Patent Application Publication
(10) Pub. No.: US 2009/0280673 A1
(43) Pub. Date: Nov. 12, 2009

(54) QUICK CONNECT ASSEMBLY

(76) Inventor: Ran Kohen, Aventura, FL (US)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/720,656

(22) PCT Filed: Dec. 2, 2005
(86) PCT No.: PCT/US05/43934

§ 371 Date: Jun. 1, 2007

Related U.S. Application Data
(60) Provisional application No. 60/643,673, filed on Jan. 12, 2005.
(60) Provisional application No. 60/680,258, filed on May 12, 2005.

(30) Foreign Application Priority Data
Dec. 2, 2004 (US) 11/003570

(51) Int. Cl. H01R 13/60

(52) U.S. Cl. 439/366; 439/529

(57) ABSTRACT

A device for connecting and supporting fixtures, such as electrical fixtures, includes a male plug, a mating female socket and a releasable spindle assembly for both holding the plug in the socket and mechanically mounting the fixture on a supporting surface or an electrical box. The plug is provided with concentric, ring shaped male connectors that are matingly received within similarly shaped female recesses in the socket to create electrical connections and also allow the fixture to be rotated to any of a plurality or mounting orientations. The releasable spindle assembly is controlled by the actuation of a push rod operated by a tool or user's finger.

### TECHNICAL FIELD

The present invention relates to electrical connectors and fixtures, and more particularly, to an electrical plug and socket combination allowing quick connection and mounting of electrical fixtures at electrical outlets.

### BACKGROUND ART

Traditional techniques for installing electrical fixtures and appliances such as lighting fixtures and fans on walls or ceilings usually require the assistance of a qualified electrician, and the use of a variety of tools and specialized hardware. The procedure for installing or uninstalling such fixtures can also be relatively time consuming, even when performed by an experienced installer. In addition to the need for hand-wiring the necessary electrical connections between the fixture and electrical power supply wiring, the installer must make separate mechanical connections for supporting or suspending the fixture in place.

One solution to the problem is disclosed in PCT Publication No. WO 0016442 (“PCT '442”). PCT '442 discloses a plug and socket combination that permits quick connection of an electrical fixture or appliance at an electrical junction box on a wall or ceiling. The socket is secured on the wall or ceiling near electrical power supply wiring and includes a pair of hollow, female receptacles which receive male electrical prongs carried on the plug. The electrical fixture is secured to the plug. In addition to the quick electrical connection provided by this plug and socket combination, a mechanical connection between the plug and socket carries the mechanical load of the electrical fixture.

An improvement to the plug and socket described above is disclosed in PCT Publication No. WO 03044906 (“PCT '906”). The plug and socket combination shown in PCT '906 employs arcuately shaped electrical interconnections in the form of ring shaped male plug elements received within correspondingly shaped female receptacle openings. By this arrangement, the plug, along with the electrical fixture to which it is attached, can be freely rotated by the installer to a desire rotational position.

A still further improvement in the art is shown in Israeli Patent Application No. 159032 filed Nov. 24, 2003. In this Israeli application, a revolvable plug and socket combination is disclosed which includes means for selectively locking the plug and socket against relative rotation. By this feature, a user may lock the fixture against further rotation once the installer has indexed it to a desired orientation.

Accordingly, there exists a need for a universal device that can be used in a wider range of applications and gain widespread acceptance, while satisfying local and national building codes and standards. The present invention is intended to satisfy this need in the art.

### SUMMARY OF THE INVENTION

According to one aspect of the invention, a device is provided for quickly connecting an electrical fixture with electrical power supply wiring, and for mounting the fixture on a support. The device includes a socket including a socket body having at least one internal cavity therein; an electrically conductive contact terminal disposed within the cavity for establishing an electrical connection between the electrical power supply wiring and the socket, the contact terminal having a portion thereof captured between internal surfaces of the socket body to hold the contact terminal in a fixed position without the need for fasteners; a plug rigidly fixed to the fixture and insertable into the socket, the plug having at least one male connector electrically connected to the fixture and engageable with the contact terminal within the socket to establish a circuit between the electrical fixture and the electrical power wiring; and, a releasable latch carried on the combination of the plug and the socket for releasably mounting the fixture on the support. The elimination of fasteners to hold the contact terminal in place not only reduces the cost of the device but also speeds manufacturing and assembly of the device.

According to another aspect of the device, compression springs are mounted within the socket cavities to supplement the spring force of the contact terminals, thus assuring reliable connection between the contact terminals and male connectors within the plug.

According to still another aspect of the invention, wire access holes are provided in both the top and the sides of the socket, thus giving the installer a choice of either top feed or side feed of the electrical supply wires into the socket. The contact terminals are configured to provide a similar choice of top or side feed, allowing the device to be installed in a wide range of applications.

According to a further aspect of the invention, a cover may be installed in the socket, overlying the wall or ceiling area around the device to provide a more pleasing aesthetic appearance when a fixture has not yet been installed.

In those installations where it is not possible to gain direct access to the centrally located latch, a lateral actuator assembly is provided for controlling the latch.

Accordingly, it is a primary object of the present invention to provide a device that facilitates quick electrical and mechanical connections between an electrical fixture and an electrical outlet on a wall, ceiling or floor.

Another object of the invention is to provide a device of the type mentioned above that can be used by unskilled or inexperienced users to quickly and easily install electrical fixtures.

A further object of the invention is to provide a device as described above which permits the electrical fixture to be rotated into a desired position during or after installation, and then locked in place.

Another object of the invention is to provide a device of the type mentioned which is suitable for universal use in a complete range of applications and environments, and which meets existing building codes and national electrical standards.

A still further object of the invention is to provide a device of the type referred to above which allows a user to install or remove an electrical fixture from an electrical supply box without the need of special tools or the assistance of a trained electrician and to do so easily and quickly.

Another object of the invention is to provide a device as described which is capable of connecting a wide variety of electrical appliance and fixture configurations to various types of wall, ceiling or floor outlets, electrical junction boxes or even flat wall surfaces that are not provided with electrical outlets.

A still further object of the invention is to provide a device as described above which possesses a minimum number of parts, avoids the use of fasteners where possible and can be manufactured in high volume using automated production techniques.

These, and further features and advantages of the present invention will be made clear or will become apparent during the course of a description of a preferred embodiment of the invention.

### BRIEF DESCRIPTION OF THE DRAWINGS

In the drawings, which form an integral part of the specification and are to be read in conjunction therewith, and in which like reference numerals employed to designate identical components in the various views:

FIG. 1 is a perspective view of a quick connect device for electrical fixtures which forms an exemplary embodiment of the present invention, the plug being shown separated from a socket;

FIG. 2 is an exploded, perspective view of the device shown in FIG. 1;

FIG. 3 is a medial cross sectional view of the device shown in FIG. 1 taken along line 3-3 of FIG. 12, also depicting the plug separated from the socket;

FIG. 4 is a view similar to FIG. 3 but showing the plug installed within the socket;

FIG. 5 is a perspective view of a modified form of the device, provided with an extension rod useful in installing certain types of electrical fixtures;

FIG. 6 is an exploded, perspective view of the socket, depicting the relative positions of the electrical contact terminals;

FIG. 7 is a perspective view of a modified form of the socket suitable for installation on a flat ceiling or wall;

FIG. 8 is a perspective view of a blank cover suitable for covering the socket when not in use;

FIG. 9 is a fragmentary, medial cross-sectional view showing the cover depicted in FIG. 8 having been installed over a socket mounted in a ceiling-mounted electrical box;

FIG. 10 is a fragmentary, partially medial sectioned view showing a modified form of the device useful for mounting certain types of electrical fixtures such as electric fans or chandeliers, and depicting a latching mechanism in its locked position;

FIG. 11 is a view similar to FIG. 10 but showing the latching mechanism moved to its released position;

FIG. 12 is a plan view of the top of the socket, the socket cover having been removed to reveal details of the contact terminals;

FIG. 13 is a perspective view of the socket of the quick connect device which forms another exemplary embodiment of the present invention, the socket is shown having a plurality of radial projections or ears extending from an outer wall;

FIG. 14 is a cross sectional view of the socket shown in FIG. 13, the socket includes a central bushing having a plurality of circumferentially extending shoulders;

FIG. 15 is a perspective view of a spindle assembly of the plug, the spindle assembly is shown having multiple sets of retaining balls;

FIG. 16 is a cross sectional view of the spindle assembly of FIG. 15;

FIGS. 17 and 18 are perspective views of the plug showing the multiple sets of retaining balls and a plurality of tangential wire channels;

FIG. 19 is a perspective view of a combination including a plug, a latching mechanism, and a canopy;

FIG. 20 is an enlarged perspective view of the latching mechanism of FIG. 19;

FIG. 21 is a perspective view of a pivot rod of the latching mechanism of FIG. 20;

FIG. 22 is a perspective view of a leaf spring of the latching mechanism;

FIG. 23 is a perspective view of a handle of the latching mechanism;

FIG. 24 is a perspective view of an adapter of the latching mechanism;

FIG. 25 is a perspective view of a clamp of the latching mechanism;

FIGS. 26A-26E are perspective views of exemplary canopies of the present invention;

FIG. 27 is a perspective view of yet another embodiment of the latching mechanism shown with a plug and canopy;

FIGS. 28 and 29 are perspective views of the latching mechanism of FIG. 27;

FIG. 30 is a perspective view of the present invention shown with a remote control unit;

FIG. 31 is an exploded, perspective view of another exemplary embodiment of a quick connect device for electrical fixtures and the like, the fixture and outlet box not shown for purposes of clarity;

FIG. 32 is an exploded, cross sectional view of the device shown in FIG. 31;

FIG. 33 is a cross sectional view similar to FIG. 32, but showing the plug portion of the device having been inserted and locked in the socket of the device;

FIG. 34 is a perspective view of an electrical junction box with a mounting strap secured thereto;

FIG. 35 is a perspective view of the plug having a fixture secured thereto, parts of the fixture being broken away;

FIG. 36 is a perspective view similar to FIG. 35, but showing the plug and fixture having been installed on the junction box shown in FIG. 34;

FIG. 37 is a perspective of the bottom of the fixture, showing a finger grip and push button of the device;

FIG. 38 is a perspective view of the top of the fixture shown in FIG. 37, depicting the upper end of the plug of the device;

FIG. 39 is an exploded, perspective view of the plug in relationship to a button used to operate the plunger;

FIG. 40 is a perspective view of an optional extension rod that may be installed to operate the plunger;

FIG. 41 is a perspective view of another exemplary embodiment of the quick connect device of the present invention;

FIG. 42 is an exploded, perspective view of a plug of the device in FIG. 41;

FIG. 43 is an exploded, perspective view of a socket of the device in FIG. 41;

FIGS. 44, 44A, and 45 are perspective views of electrical terminal blocks of the socket;

FIGS. 46 and 47 are perspective views of a socket skirt;

FIG. 48 is a perspective view of a socket cover; and

FIG. 49 is a perspective view of another exemplary latching mechanism.

### DETAILED DESCRIPTION OF THE INVENTION

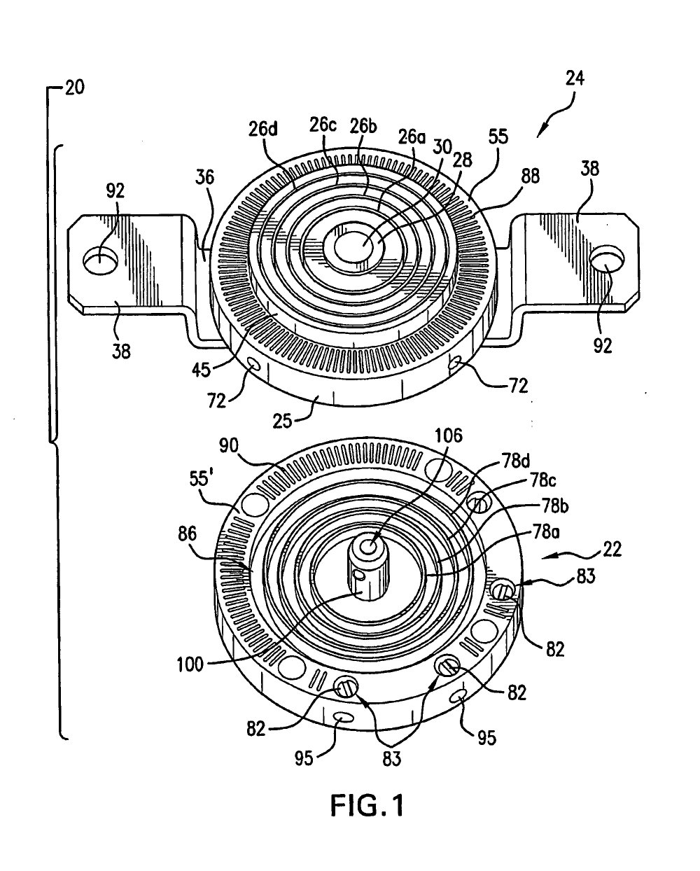

Referring first to FIGS. 1-4, a quick connect device 20 for installing electrical fixtures comprises the combination of a plug 22 and mating socket 24. The device 20 functions to both establish an electrical connection between an electrical fixture and electrical supply wiring, and mechanically support the fixture on a surface or base, typically a wall, ceiling or floor surface. As used herein, the term “fixture” or “electrical fixture” means any fixture or appliance such as a lighting fixture, ceiling fan, television camera, security device or any other device which is powered by electricity supplied by electrical wiring, and which requires a mechanical connection to support or suspend the fixture. Plug 22 is fixedly secured to an electrical fixture (not shown), while the socket 24 is secured to either the surface (e.g., wall, ceiling or floor) on which the fixture is to be mounted, or to an electrical junction box.

The socket 24 comprises a cylindrically shaped, essentially hollow body 25 having a flat circular cover 66, both formed of non-conductive material such as phenolic resin. Four concentric, ring shaped, female recesses or slots 26a, 26b, 26c, 26d are formed in one face of the socket 24, and are configured to matingly receive four, later discussed male connector rings on the plug 22 to establish electrical connections between the plug 22 and the socket 24. The socket 24 includes a center through hole within which there is fixedly secured a metal bushing 28. The bushing 28 is provided with two concentric bores 30, 32 of differing diameters to define a circumferentially extending shoulder 34. In the illustrated embodiment, bushing 28 passes through and is fixedly secured to an elongate mounting strap 36 as by welding. It should be noted here however, that the bushing 28 and the strap 36 could be of unitary construction, formed of a single piece of high strength material, such as metal as by casting, machining or other metal working processes.

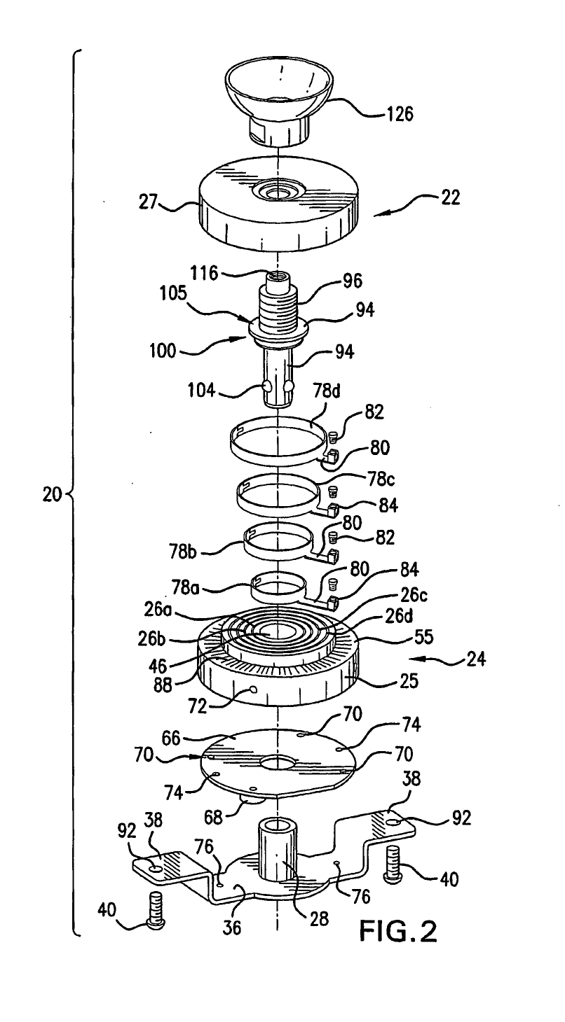

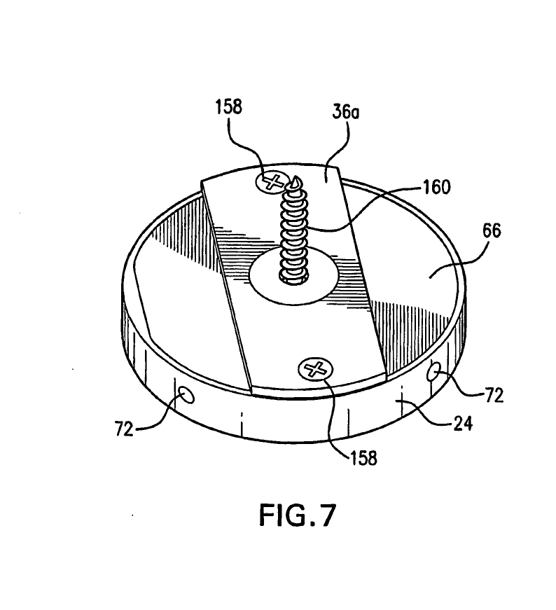

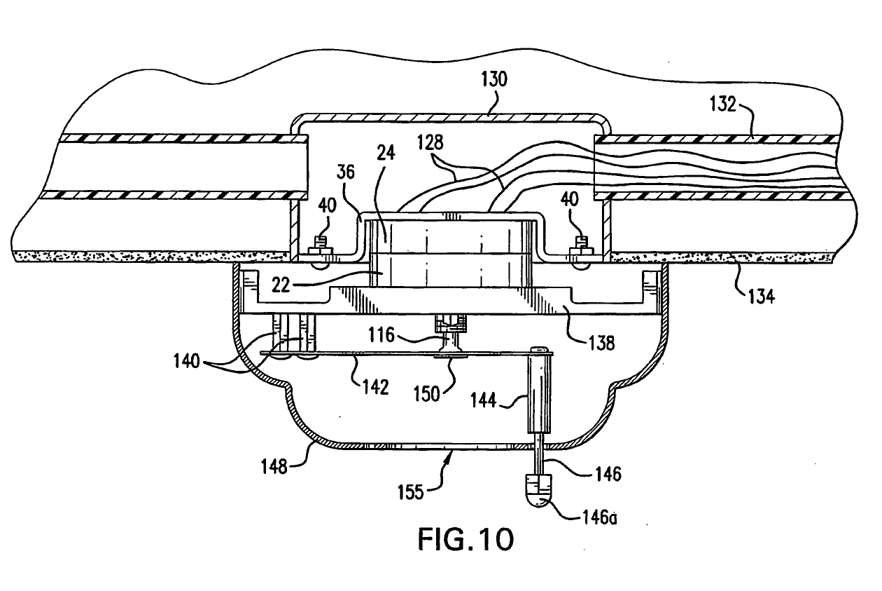

As best seen in FIGS. 1 and 2, mounting strap 36 is generally U-shaped and is provided with an aperture 92 on each of its outer extremities or flanges 38 which receives a screw 40 to mount the strap 36, and thus the entire device 20, on a suitable mounting surface. In the Illustrated embodiment, the spacing between the apertures 92 is selected so that the strap 36 can be affixed to a common electrical junction box (not shown) formed of metal or plastic and having threaded holes or nuts into which the screws 40 may be driven. The U-shaped configuration of the strap 36 allows the socket 24 to be recessed within the junction box, as illustrated in FIG. 10. However, in those applications where it is necessary to mount the socket 24 directly on a wall or ceiling without use of a junction box, a flat strap 36a may be employed, as shown in FIG. 7. In the illustrated example, the socket 24 is secured to the strap 36 by means of screws passing through openings 76 of the strap 36, into the cover 66. However, other techniques may be used to secure the socket body 25 to the combination of the strap 36 and bushing 28. For example, the top of the cover 66 could be provided with nipples that extend through the strap openings 76 and are deformed, as by melting to rigidly fix the strap 36 to the top of the cover 66. Alternatively, the bushing 28 could be provided with laterally extending surface features that are integrally molded into the body 25 of the socket 24.

The cover 66 is received within a ring shaped recess in one face of the socket 24 and may be affixed to the body 25 of the socket 24 by any suitable means such as, for example, ultrasonic welding or snap fit. The cover 66 is provided with four upstanding bosses 68 circumferentially spaced around its periphery. Each of the bosses 68 includes a tapered access opening 70 communicating with the hollow interior of the socket 24. A second set of four access openings 72 are provided in the outer wall of the socket body 25.

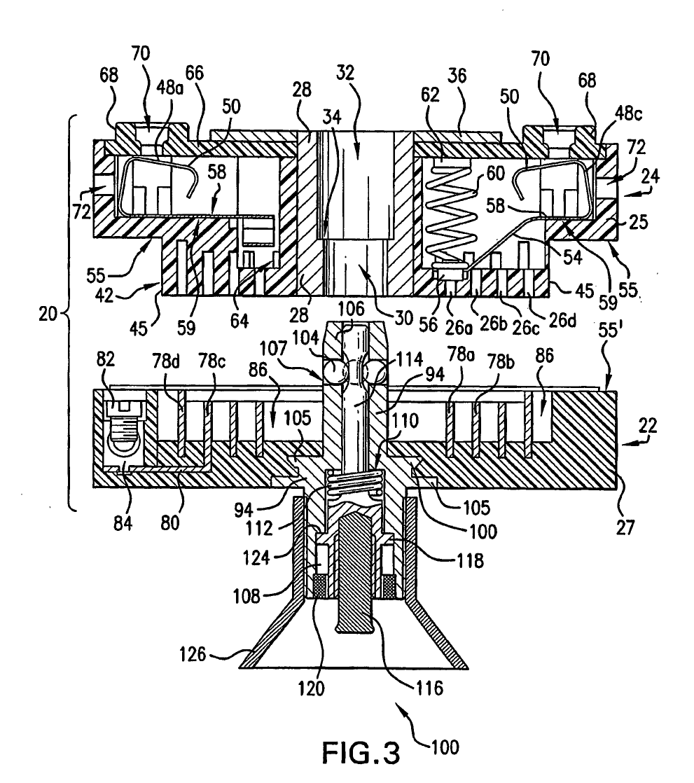

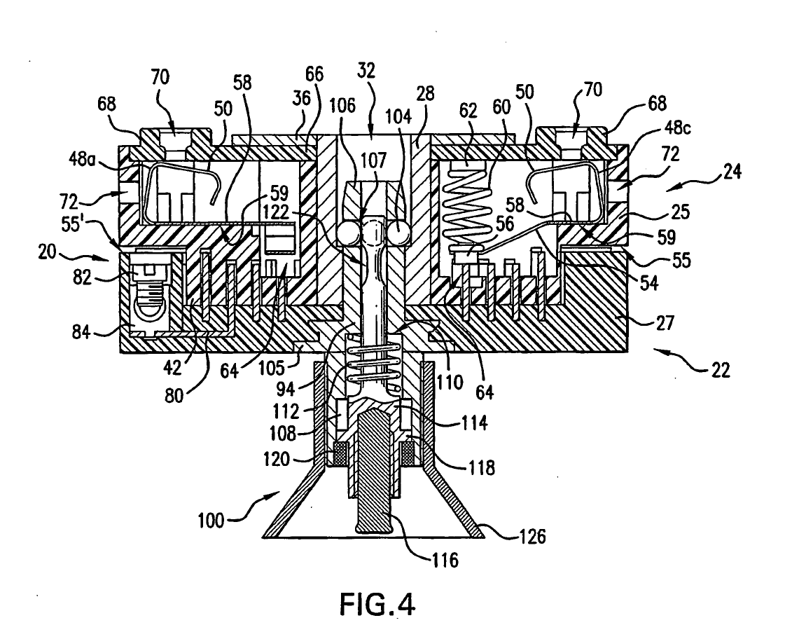

As best seen in FIGS. 3 and 4, the female slots or recesses 26a-26d extend axially into the socket body 25 and each communicates with a contact opening 64 at a location around the circumference of the slot or recess. In the illustrated embodiment, slots or recesses 26a-26c are of essentially equal depth, while recess 26d is of a greater depth for purposes which will become later apparent. The socket body 25 is provided with circumferential notch 42 defining an annular face 55 that is intended to engage a later discussed, corresponding face 55′ on the plug body 27 and acts as a stop to limit the entry of the plug 22 into the socket 24. Annular faces 55 and 55′ are provided with a plurality of circumferentially spaced, radial extending indexing teeth 88, preferably integrally molded into the socket and plug bodies 25 and 27 that interengage or mesh when the bodies 25 and 27 are mated to prevent the bodies 25 and 27 from rotating relative to each other. Prior to the teeth 88 of the bodies 25 and 27 engaging, the bodies 25 and 27 free to rotate relative to each other.

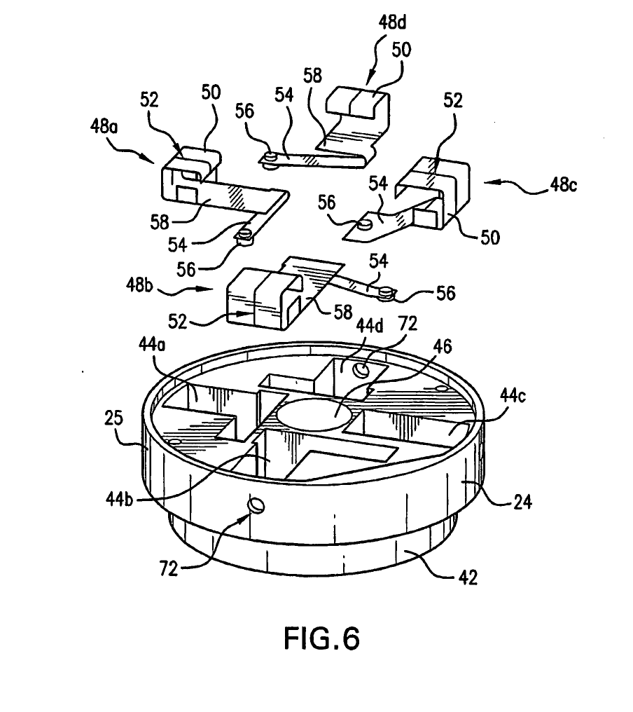

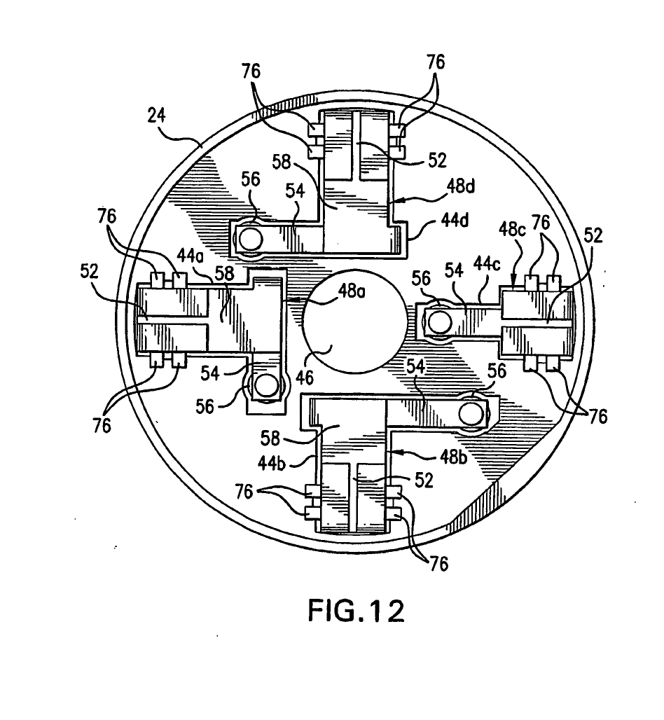

Referring now to FIGS. 6 and 12, the socket body 25 includes four circumferentially spaced cavities 44a-44d therein, as illustrated in FIG. 6, within which there are respectively disposed four electrical contact terminals 48a-48d. Contact terminals 48a-48d are preferably formed from electrically conductive, spring beryllium copper or steel using precision stamping techniques to produce the individual features of the terminal. Each of the terminals 48a-48d includes a flat intermediate section 58 which rests on a ledge 59 formed within the associated cavity 44a-44d. An upper extremity 50 of the terminals 48a-48d includes a split bent leg or pair of bent legs side by side and include centering lugs on each side which respectively contact an inner wall of the body of the plug 24 and the bottom face of the cover 66. By this series of contact points between the terminals 48a-48d and the inside surfaces of the socket 25 and cover 66, the terminals 48a-48d are tightly captured within the cavities 44a-44d, respectively aligned with an associated slot or recess 26a-26d, and are electrically insulated from each other. In FIG. 12, two spaced centering lugs 76 are provided on each side, for better insertion of a wire into the extremity 50.

The lower extremity of each of the contact terminals 48a-48d includes a spring leg 54 which extends downwardly into a corresponding one of the contact openings 64. Each of the spring legs 54 is flexible about its upper end which is connected by a bend to the intermediate section 58. The lower end of each of the spring legs 54 is provided with an electrical contact member 56 which overlies and is in radial registration with a corresponding one of the recesses 26a-26d, as best seen in FIGS. 3 and 4. Contacts 56 each include a cylindrical boss on their upper end which is received within and functions to retain a compression spring 60 whose upper end is held in place against the cover 66 by a retainer 62 affixed to the bottom side of the cover 66. Compression springs 60 supplement the spring force provided by spring legs 54 to urge the electrical contacts 56 downwardly into the contact openings 64, adjacent the corresponding recesses 26a-26d.

Each of the contact terminals 48a-48d is provided with a split or narrow gap or slot 52 which extends through the length of angularly offset top and sides of the upper extremity of each terminal 48a-48d. The width of each of the slots 52 is selected so as to be substantially less (close to zero) than the diameter of the electrical connecting wire which delivers power to the socket 24. Thus, the exact width of the slots 52 will depend on the gauge of the electrical wiring in a given application. The bare, stripped end of the electrical supply wire is connected to the socket 24 by inserting the wire end into one of the tapered access openings 70 and forcing the end of the wire through or into the slot 52 wherein the bifurcated parts of the terminal provide a spring pressure against the inserted wire and thereby tightly grip the wire. Because the slot 52 extends completely to the end of the upper extremity of the terminal 48a-48d, the sides of the upper portion of the terminal yields to the entering supply wire, causing slot 52 to expand which both accommodates the passage of the supply wire and captures it under spring pressure, thereby making a reliable electrical connection.

In some applications, it may not be convenient or possible to feed the electrical supply wires through the top face of the socket body 25. In this case, the electrical supply wires may be positioned through access openings 72 in the side wall of the socket body 25, where again they are forced through the corresponding slot 52 in order to establish electrical connection to the socket 24.

Referring now to FIGS. 1-4, the plug 22 includes a body 27 formed out of non-conductive material, which can be identical to the material used to form the socket body 25, and includes a cylindrical cavity 86 in one face thereof. Four concentric, male connector rings 78a-78d are integrally molded into the plug body 27, with sufficient radial spacing therebetween to electrically insulate them from each other. The diameters and spacing of the male connector rings 78a-78d are such that they are alignable with and receivable within the corresponding female recesses 26a-26d in the socket 24. Each of the connector rings 78a-78d includes an integrally formed lateral extension 80 which ends in a terminal block 84. The terminal blocks 84 are circumferentially spaced from each other so as to lie along a circle, near the outer periphery of the plug body 27. The plug body 27 is provided with four, spaced-apart, lateral wire openings 95 therein which are circumferentially aligned with the connector blocks 84. Four additional, circular openings 83 are provided in the top face 55′ of the plug body 27 which are circumferentially aligned with and provide access to the terminal blocks 84. Set screws 82 pass through openings 83 and are received within threaded holes in the top of the terminal blocks 84. Electrical wiring from the electrical fixture which is attached to the plug 22 is positioned through the lateral wire openings 95 so that the stripped ends of the wire pass into the lateral openings in the terminal blocks 84. Set screws 82 provide a means of tightly securing the electrical wire ends on the terminal blocks 84, thereby connecting the fixture with the male connector rings 78a-78d.

The plug 22 as well as the fixture attached thereto, is mechanically connected to the socket 24 and to the mounting strap 36 by means of a centrally located, releasable spindle assembly 100 which will now be described in detail. The spindle assembly 100 includes a barrel 94 having a series of coaxial bores therein, and a plunger or pin 114 axially slidable within the barrel 94. The barrel 94 includes a plurality of retaining balls 104 captured within radial openings 107 in the barrel 94. The upper end 106 of pin 114 is provided with a reduced diameter section forming a recess or ball detent 122 into which the retaining balls 104 may be inwardly displaced. The lower end of the barrel 94 includes two axially aligned bores having successively greater diameters, so as to define a pair of annular shoulders 110, 124. A compression spring 112 is sleeved over the pin 114 and is captured between shoulder 110 and the bottom portion of the pin 114, thereby normally biasing the pin 114 to move downwardly (outwardly) into a latched or locking position, wherein the pin 114 forces retaining balls 104 outwardly until they rest against the shoulder 34 within bushing 28. Downward travel of the pin 114 is limited by an annular retainer 120 received within the end of the barrel 94. Pin 114 includes an annular flange or lateral extension 118 which slides within barrel opening 108 until it contacts the retainer 120.

In an exemplary embodiment, the spindle assembly 100 is attached to the plug body 27 by means of annularly shaped, lateral extensions or flanges 105 on the barrel 94 which are integrally molded into the plug body 27. A push button 116, which extends from the lower end of the barrel 94, provides a means of actuating the spindle assembly 100 using either a finger or a tool. A guard cover 126 is secured to the lower end of the barrel 94 and includes a splayed lower portion surrounding the end of the push button 116. As seen in FIG. 2, the lower end of the barrel 94 is threaded 96 so as to receive internal threads on the guard cover 126. The guard cover 126 not only protectively covers the sides of the push button 116 in order to prevent inadvertent actuation of the latter, but acts as a guide to lead a user's finger or tool onto the end of the push button 116. Further, the cover 126 provides a means of gripping and holding the plug 22 during the installation process; the user places the index and middle fingers on the splayed lower portion of the cover 126 while the thumb actuates the push button. Guard cover 126 can also be used to mount a fixture to the plug 22.

The electrical fixture may be secured to the plug 22 in any of a variety of ways. For example, the fixture may be fixedly attached by or to the guard cover 126, or directly to the lower threaded section of the barrel 94. Alternatively, the fixture may be secured to a piece of mounting hardware, such as a “hickey” threaded onto the lower end of the barrel 94. In any event, it may be appreciated that the weight of the fixture is transmitted through the barrel 94, retaining balls 104, and bushing 28 to the mounting strap 36, which in turn is secured to the junction box, wall or other structure on which the fixture is to mounted.

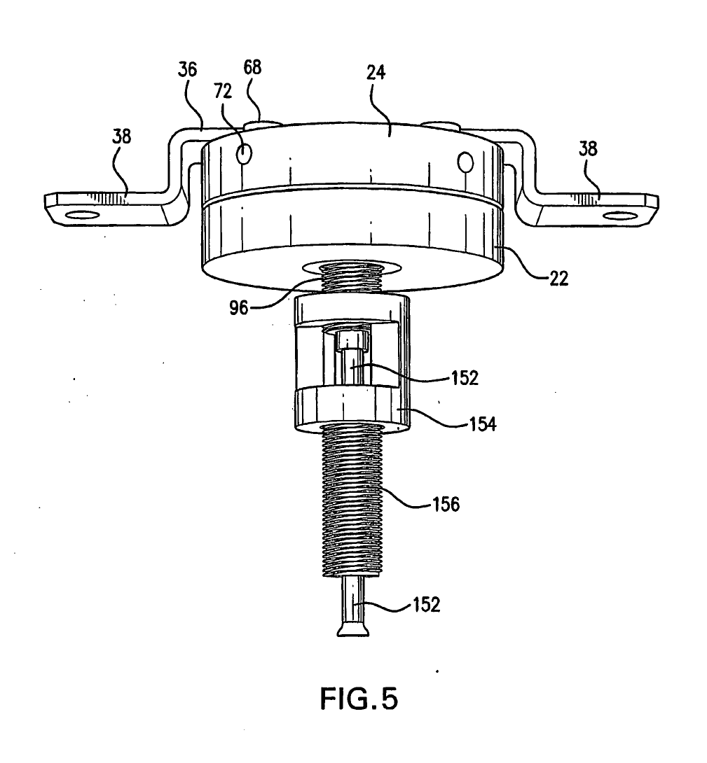

Referring now to FIG. 5, in some installations it may be necessary to effectively extend the length of the spindle assembly 100 where, for example, a motor or other parts of the electrical fixture are covered by a downwardly extending shroud or canopy (not shown). In this event, additional hardware such as a threaded hickey 154 is screwed onto the lower threaded portion 96 of the barrel 94. A threaded guide barrel 156 is in turn screwed into the lower end of the hickey 154. Either a long push rod 152 is utilized which is attached at its upper end to the pin 114, or the current push rod 116 is provided with a tapped hole and push rod 152 is provided with a threaded extension for threading into the tapped hole. The push rod 152 is guided by the guide barrel 156, with its lower end 152 extending beyond the lower end of the barrel 156. The configuration shown in FIG. 5 is also advantageous in that the electrical fixture may be mechanically mounted on the hickey 154 by suitable fasteners or by welding, or on the threaded guide barrel 156.

In some installations, a recessed electrical junction box may not be available to provide the means of mechanically mounting the device 20 on a surface. In this case, as shown in FIG. 7, the socket 24 may be secured to a flat mounting surface, such as a wall or ceiling, by means of a screw or lag bolt 160 which is secured to a modified, flat mounting strap 36a. Mounting strap 36a is in turn attached to the cover 66 by means of screws 158. In this embodiment, wires (not shown) supplying electricity are positioned through the access openings 72 in the side of the socket body 25. As shown in FIG. 7, the strap 36a does not extend beyond the outer periphery of the socket 24, thereby concealing the strap 36a and providing a more pleasing appearance.

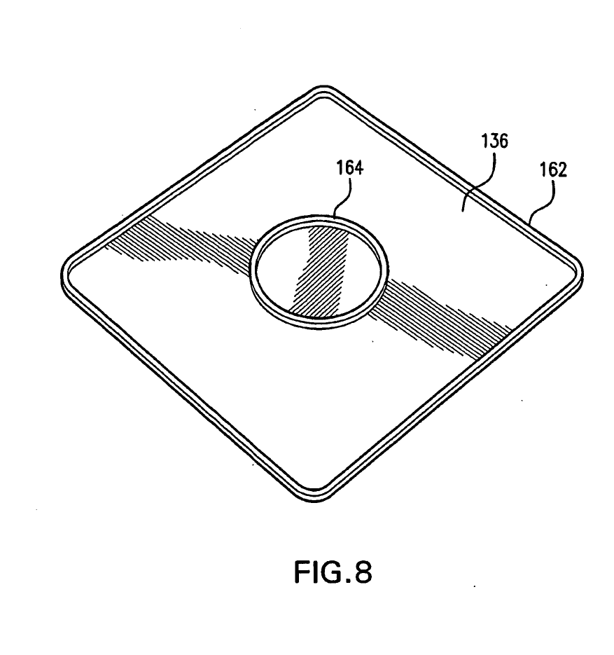

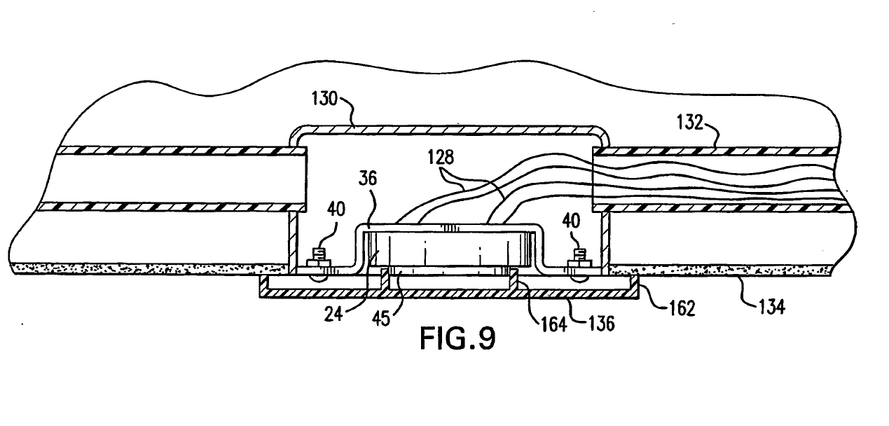

FIGS. 8 and 9 depict a blank cover 136 which may be used to cover the socket 24 where a fixture has not yet been mounted on an electrical outlet. As shown in FIG. 9, an electrical junction box 130 is recessed within a ceiling or wall 134 and is connected with conduits 132 which enclose electrical wires 128 providing electricity to the socket 24. Socket 24 is secured to a metal mounting strap 36, as previously described which in turn is secured to junction box 130 by means of screws with or without nuts 40. The blank cover 136 includes an upstanding, peripheral edge 162, and a centrally located, raised mounting ring 164. The mounting ring 164 is received in tight frictional engagement over the lower cylindrical portion 45 of the socket 24. This frictional engagement is sufficient to hold the cover 136 in place, with the outer edge 162 in engagement with the wall or ceiling 134.

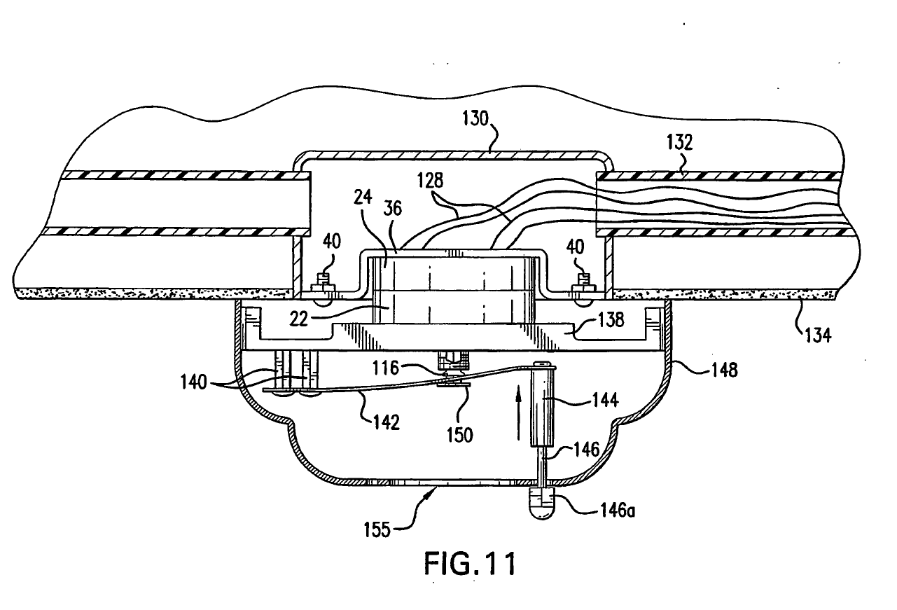

In some installations where the electrical fixture includes a structure such as a motor, it may not be possible to gain direct access to the centrally located spindle assembly 100 and push rod 116, even if the length of the latter is extended. In such installations, a modified form of the device 20 may be used, as shown in FIGS. 10 and 11. A support member 138 includes a central threaded aperture for receiving the lower threaded end 96 of barrel 94, thus securely mounting support member 138 on the junction box 130 through the mounting flange 36. Support member 138 extends laterally on each side of the central axis of the spindle assembly 100 and has it outer ends engaging the sidewall of a canopy 148 which may be directly attached to the support member 138.

Canopy 148, which is employed primarily for aesthetic purposes, encloses the exposed box 130 as well as wiring and structure such as a motor (not shown) or other equipment forming part of the electrical fixture. A pair of mounting spacers 140 secured to the support member 138 extend downwardly from the latter and have secured thereto one end of a flexible lever 142 formed, for example, of spring steel, synthetic material or other spring-like material, and constitutes a flat leaf spring which returns to its original shape after deflection. Medial portions of the lever 142 are secured to the push rod 116 by a retainer 150, which can simply be the top portion of rod 116. The opposite end of the lever 142 has an extension rod 144 secured thereto which includes a downwardly extending reduced diameter section 146 passing through an opening in the canopy 148 and having a knob 146a on its free lower end.

With rod 144 in its normal, down position shown in FIG. 10, the spindle assembly 100 is locked, securing the plug 22 in the socket 24 and forming a mechanical connection that supports the weight of the fixture on the mounting strap 36. Although not specifically shown in the drawings, a mechanical structure such as a fan motor is mounted inside a canopy 148, directly beneath the push rod 116, and extends downwardly through an opening 155 in the canopy 148.

In order to release the plug 22 from the socket 24 and disengage the mechanical connection supporting the fixture, the user moves rod 144 upwardly, causing lever 142 to deflect, which in turn displaces the push rod 116 upwardly. This upward movement of the push rod 116 also displaces the pin 114 upwardly, allowing the retaining balls 104 to move into the depressions 122, thus releasing the spindle assembly 100 and allowing the barrel 94 to be removed from the bushing 28.

Having described details of the preferred embodiment of the device 20, and various modifications thereto, the use and operation of the device 20 will now be explained. The socket 24 is first installed either on an electrical junction box 130 or directly on a wall or ceiling surface. The installer then connects electrical supply wires 128 to the socket 24 by passing the bare ends of the wires 128 into either wire openings 70 or 72, depending how the socket 24 is mounted. The wire ends are then forced into the slots 52 in the contact terminals 48a-48d which securely retain the wires within the socket 24 and establish an electrical connection between the electrical supply wires 128 and the electrical contact members 56.

The electrical fixture to be installed is first mounted on the plug 22. As previously discussed, the exact mounting method will vary, depending on the type, size and configuration of the fixture. Wiring from the fixture is routed through the lateral wire openings 95 in the side of the plug body 27, and fed into the lateral openings in the terminal blocks 84. The set screws 82 are then screwed down onto the wire ends to secure the latter in place.

Having secured the fixture to the plug 22, the installer first depresses the push rod 116, to displace the pin 114 until the depressions 122 align with the balls 104. The balls 104 move into the depressions 122, allowing the upper cylindrical section 106 of the barrel 94 to pass into the bore 30. As the insertion process continues, the male connector rings 78a-78d enter and move through the respectively associated female socket recesses 26a-26d until they engage the respectively associated contact members 56, thereby establishing electrical connection between the fixture and the contact terminals 48a-48d. The springs 60 hold contacts 56 firmly against the rings 78a-78d to assure a continuous, reliable electrical connection. At this point, the installer releases the push rod 116, whereupon spring 110 axially displaces the pin 114 to its normal locking position, forcing the balls 104 outwardly until they engage the shoulder 34 to hold the pin 114 in its locked position. The two sets of indexing teeth 88, 90 respectively carried on the socket body 25 and the plug body 27 respectively, mesh and matingly engage each other to lock the plug 22 and socket 24 against relative rotation, causing the fixture to be held in a desired orientation selected by the installer.

If it is desired to rotate the fixture to a different position, the installer need only depress the push rod 116 and withdraw the plug 22 from the socket 24 a slight distance sufficient to disengage the teeth 88, 90 from each other, at which point the fixture may be rotated to a different position. With the fixture repositioned, the plug 22 is inserted back into its fully seated position against the socket 24 and the push rod 116 is released to lock the fixture in place. The full circle configuration of the connector rings 78 and the recesses 26 allows the fixture to be fixed in virtually any rotational position. However, it should be noted here that the connector rings 78 in the plug 22 and the mating recesses 26 in the socket 24, could be configured to extend less than a full 360 degrees, for example 180 degrees, in which case the fixture will only be rotatable to positions with the range permitted by the circumferential extent of the connector rings and corresponding recesses.

With the fixture installed as described above using the device 20, the supplied electrical power flows from the supply wiring to the contact terminals 48a-48d, and thence through the contacts 56 to the connector rings 78a-78d. From the connector rings 78a-78d, electrical power flows to the terminal blocks 84, and then to the fixture. In an exemplary embodiment, four connections are shown: a ground, a neutral and two lines, however, it is to be understood that fewer or a greater number of connections can be made (such as three or five), depending on the requirements of a given application. Advantageously, in the illustrated embodiment, connector ring 78d carries the ground connection. Because connector ring 78d possess a greater depth or height than the other connector rings, the ground connection is made before the other connections are established, thus assuring that any unintended short circuit electrical current present in the device 20 is safely carried to ground before the other “hot” connections are made.

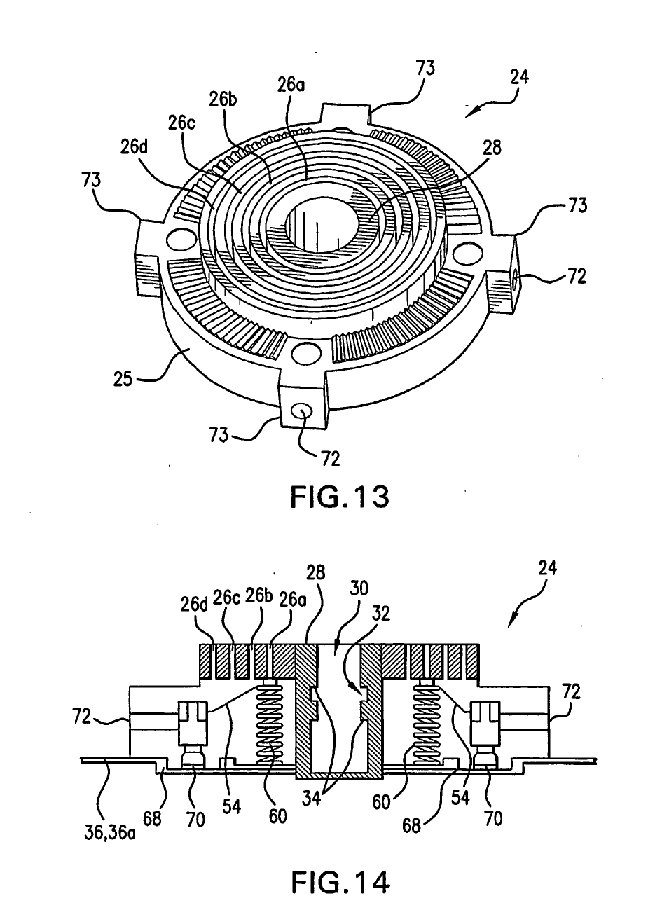

In another exemplary embodiment shown in FIGS. 13 and 14, a quick connect device for installing electrical fixtures includes the combination of a plug 22 and mating socket 24. (Plug 22 is shown in FIGS. 17 and 18). The device functions to both establish an electrical connection between an electrical fixture and electrical supply wiring, and mechanically support the fixture on a surface or base, typically a wall, ceiling or floor surface. As used herein, the term “fixture” or “electrical fixture” means any fixture or appliance such as a lighting fixture, ceiling fan, television camera, security device or any other device which is powered by electricity supplied by electrical wiring, and which requires a mechanical connection to support or suspend the fixture. The plug 22 is fixedly secured to an electrical fixture (not shown), while the socket 24 is secured to either the surface (e.g., wall, ceiling or floor) on which the fixture is to be mounted, or to an electrical junction box.

The socket 24 comprises a cylindrically shaped, essentially hollow body 25 having a flat circular cover, both formed of non-conductive material such as phenolic resin. Four concentric, ring shaped, female recesses or slots 26a, 26b, 26c, 26d are formed in one face of the socket 24, and are configured to matingly receive four, later discussed, male connector rings on the plug 22 to establish electrical connections between the plug 22 and the socket 24. The socket 24 includes a center through hole within which there is fixedly secured a metal bushing 28. The bushing 28 is provided with two or more concentric bores of differing diameters to define one or more circumferentially extending shoulders 34. The circumferentially extending shoulders 34 within the bushing 28 engage one or more retaining balls of a spindle assembly 100 of the plug 22. (The retaining balls and spindle assembly are described in more detail later.) For a spindle assembly having one set of radially projecting retaining balls, the bushing 28 may include one circumferentially extending shoulder 34 for engaging the retaining balls and connecting the plug 22 to the socket 24. Alternatively, the bushing 28 may include two or more shoulders 34 when used with a spindle assembly having one set of retaining balls. In this embodiment, one circumferentially extending shoulder may engage the retaining balls to hold the plug 22 in a temporary hanging position to facilitate other assembly or maintenance steps before the plug 22 is fully seated in a locked configuration.

It is further contemplated that the bushing 28 may include two or more circumferentially extending shoulders 34 dimensioned and configured to engage two or more sets of radially projecting retaining balls. (Again, the retaining balls are described later.) Increasing the number of shoulders 34 that engage the retaining balls increases the holding power of the plug 22 to the socket 24. For example, a bushing 28 having two circumferentially extending shoulders 34 engaged with two sets of retaining balls may at least double the strength of the plug/socket connection as compared to a single shoulder, single set of balls design. Additionally, the double shoulder, double set of balls configuration allows the plug 22 to be temporarily hung from the socket 24 to facilitate other assembly steps or maintenance. This is accomplished by engaging one set of retaining balls of the plug 22, preferably the leading set of balls, with a circumferentially extending shoulder 34 of the bushing 28, preferably the first encountered shoulder. Thereafter, the plug 22 may be further mated with the socket 24 to engage both sets of retaining balls with both shoulders 34.

The socket 24 of the quick connect device further includes one or more bosses 68 circumferentially spaced around the periphery of the cover. Each of the bosses 68 includes a tapered access opening 70 communicating with the hollow interior of the socket 24. A second set of four access openings 72 are provided in the outer wall of the socket body 25. As shown in FIGS. 13 and 14, radial projections or ears 73 extend from the outer wall of the socket body 25 thereby extending the length or depth of the access openings 72. The radial projections or ears 73 may have any cross-sectional shape including a rectangle, circle, triangle, square, etc. Preferably, the ears 73 are cube shaped with an access opening extending therethrough. The radial projections or ears 73 provide additional enclosure of the electrical wires positioned therein. Without an ear on the outer wall of the socket body 25, a stripped end portion of an electrical wire inserted into an access opening 72 may be exposed and create an unsafe condition. Therefore, the radial projection 73 enhances the safety of the socket 24 by covering any exposed, stripped electrical wire.

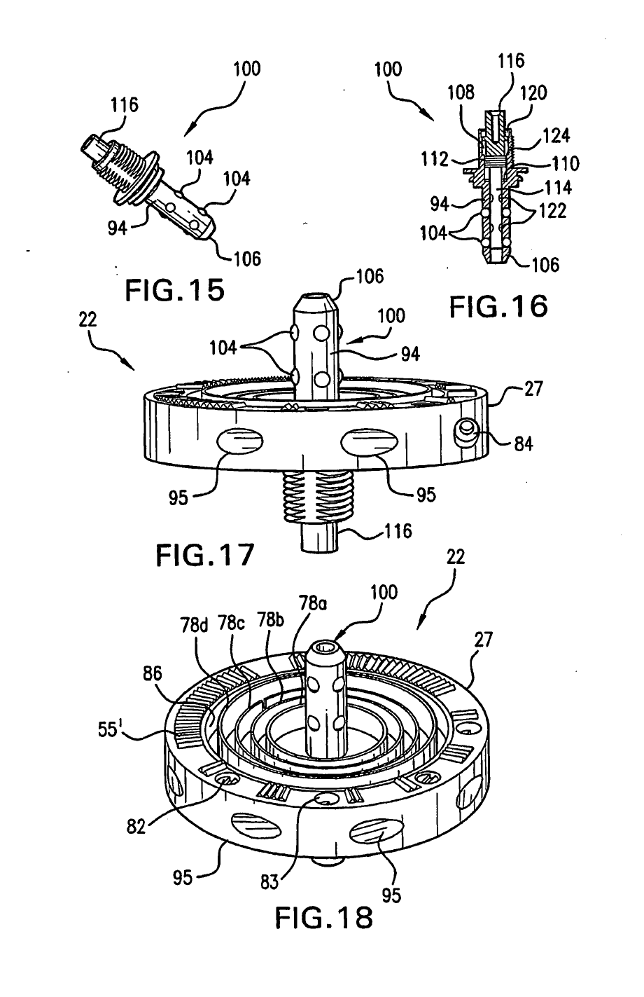

Referring now to FIGS. 15-18, the plug 22 includes a body 27 formed out of non-conductive material, which can be identical to the material used to form the socket body 25, and includes a cylindrical cavity 86 in one face thereof. Four concentric, male connector rings 78a-78d are integrally molded into the plug body 27, with sufficient radial spacing therebetween to electrically insulate them from each other. The diameters and spacing of the male connector rings 78a-78d are such that they are alignable with and receivable within the corresponding female recesses 26a-26d in the socket 24. Each of the connector rings 78a-78d includes an integrally formed lateral extension which ends in a terminal block 84. The terminal blocks 84 are circumferentially spaced from each other so as to lie along a circle, near the outer periphery of the plug body 27.

The plug body 27 is provided with four, spaced-apart, lateral wire openings 95 therein which are circumferentially aligned with the connector blocks 84. The lateral wire openings 95 form wire channels. A wire channel may extend from a lateral wire opening 95 to a connector block 84 thereby making the wire channel radially extending. Alternatively, the wire channels may be tangentially extending. In this configuration, the wire channels extend generally perpendicular to a radius of the plug body 27 or generally tangent to a circle passing through the connector blocks 84 and having its center at the center of the plug 22. Tangentially extending wire channels provide for enhanced safety of the plug 22. Since a tangentially extending wire channel may be generally greater in length or depth than a radially extending wire channel, the stripped end portion of an electrical wire may be more fully enclosed or covered thereby reducing the risk of electrocution, shorting, or fire from the exposed wire. Furthermore, radially extending wire channels may require the electrical wires therein to extend from the plug 22 radially outward. This configuration may require more space surrounding the plug to accommodate the wires. The tangentially extending wire channels permit the electrical wires protruding therefrom to reside closer to the outer wall of the plug 22 thereby requiring less space to accommodate the wires around the plug 22.

Four additional; circular openings 83 are provided in the top face of the plug body 27 which are circumferentially aligned with and provide access to the terminal blocks 84. Set screws 82 pass through openings 83 and are received within threaded holes in the top of the terminal blocks 84. Electrical wiring from the electrical fixture which is attached to the plug 22 is trained through the lateral wire openings 95 so that the stripped ends of the wire pass into the lateral openings in the terminal blocks 84. Set screws 82 provide a means of tightly securing the electrical wire ends on the terminal blocks 84, thereby connecting the fixture with the male connector rings 78a-78d.

It is further contemplated that the radial projections or ears 73 previously described in relation to the socket 24 may be applied to the plug 22. The wire channels of the plug 22 extending between the lateral wire openings 95 and the connector blocks 84 may be extended with ears 73. For radially extending wire channels, the ears 73 may be radial projections. For tangentially extending wire channels, the ears 73 may be tangential projections. In either configuration, the projections or ears provide additional enclosure of the stripped wire ends.

The plug 22, as well as the fixture attached thereto, is mechanically connected to the bushing 28 of the socket 24 by means of a centrally located, releasable spindle assembly 100 which was previously mentioned but will now be described in more detail. The spindle assembly 100 includes a barrel 94 having a series of coaxial bores therein, and a pin 114 axially slidable within the barrel 94. The barrel 94 includes a plurality of retaining balls 104 captured within radial openings 107 in the barrel 94. One or more balls may form a set of retaining balls 104 positioned within radial openings 107 of the barrel 94. Furthermore, one or more sets of balls 104 may be spaced apart along the barrel 94. Each set of retaining balls 104 are captured within radial openings 107 in the barrel 94. Therefore, a spindle assembly having two sets of retaining balls 104 may include two sets of radial openings. It is contemplated that two, three, four, or more sets of retaining balls 104 and corresponding sets of radial openings may be included in the spindle assembly 100.

As previously described, the retaining balls 104 of the spindle assembly 100 allow for the plug 22 to be mated within the bushing 28 of the socket 24. The bushing 28 includes one or more circumferentially extending shoulders 34 which engage the one or more sets of retaining balls 104 of the spindle assembly 100. Having two or more sets of shoulders 34 and retaining balls 104 increases the holding strength of the quick connect device.

In further describing the spindle assembly 100, the end portion 106 of pin 114 is provided with one or more reduced diameter sections forming recesses or ball detents 122 into which the retaining balls 104 may be inwardly displaced. The lower end of the barrel 94 includes two axially aligned bores having successively greater diameters, so as to define a pair of annular shoulders 110, 124. A compression spring 112 is sleeved over the pin 114 and is captured between shoulder 110 and the bottom portion of the pin 114, thereby normally biasing the pin 114 to move downwardly (outwardly) into a latched or locking position, wherein the pin 114 forces retaining balls 104 outwardly until they rest against the shoulders 34 within bushing 28 of the socket 24. Downward travel of the pin 114 is limited by an annular retainer 120 received within the end of the barrel 94. Pin 114 includes an annular flange or lateral extension which slides within barrel opening 108 until it contacts the retainer 120. The spindle assembly 100 is attached to the plug body 27 by way of extensions or flanges on the barrel. The flanges may be integrally molded into the plug body 27. A push rod 116, which is secured to and extends from the end of the barrel 94, provides a means of moving the pin 114 to thereby actuate the spindle assembly 100.

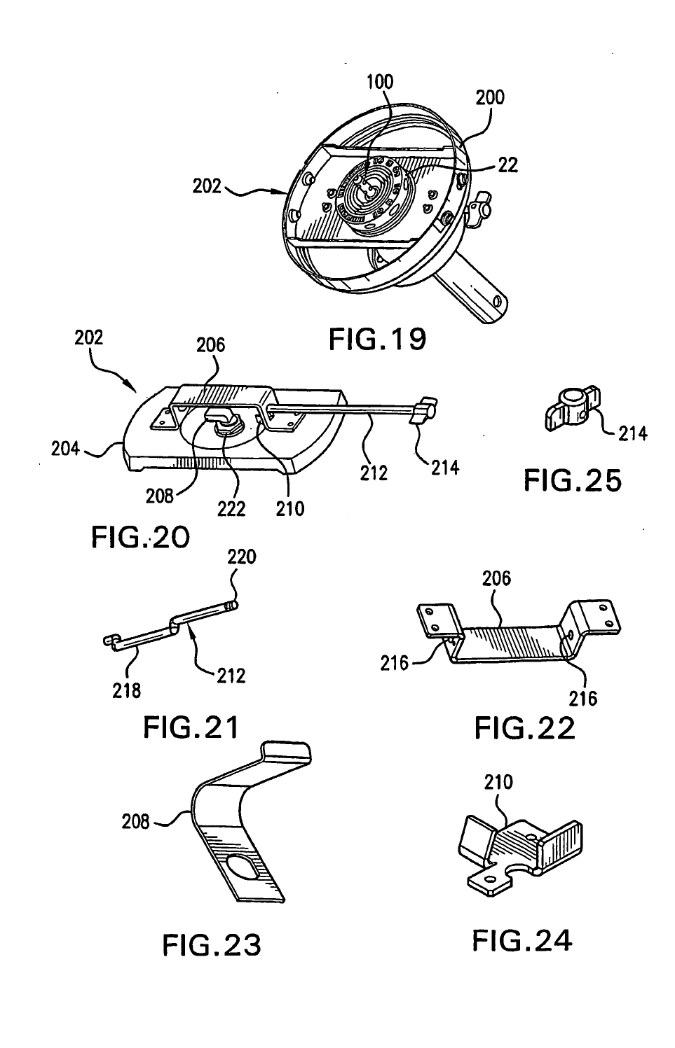

In some installations where the electrical fixture includes a structure such as a motor, it may not be possible to gain direct access to the centrally located spindle assembly 100 and push rod 116, even if the length of the latter is extended. In such installations, a modified form of the device may be used, as shown in FIGS. 19-25. The assembly shown in FIG. 19 includes a canopy 200, a latching mechanism 202, and a plug 22 of the quick connect device. The latching mechanism 202 provides for the quick release of the spindle assembly 100 from the socket 24 (not shown). Moreover, the latching mechanism 202 allows the plug 22 to be released from the socket 24 when access to the push rod 116 is prevented.

Generally, the latching mechanism 202 includes a base plate 204, an adapter 206, a leaf spring 208, a clamp 210, a pivot rod 212, and a handle 214. The adapter 206 is connected to the bottom side of the base plate 204. Preferably, the adapter 206 includes two feet that may be positioned against the bottom side of the base plate 204 and screwed, bolted, adhered, or welded thereto. The adapter 206 also includes two apertures 216. The apertures 216 are dimensioned and configured for receiving a portion of the pivot rod 212. The pivot rod 212 includes a generally offset portion 218 which is positioned between the apertures 216 of the adapter 206. A proximal portion 220 of the pivot rod 212 extends from the adapter 206. Preferably, the proximal portion 220 extends beyond an end of the base plate 204. At the proximal end of the pivot rod 212, the handle 214 is attached so the rod 212 may be easily rotated. The clamp 210 is mounted against a leg of the adapter 206. Preferably, the clamp 210 is positioned on an inner side of a leg and adjacent to the pivot rod 212. The clamp 210 includes one or more elements which engage the offset portion 218 of the pivot rod 212 as the pivot rod 212 is rotated. The elements of the clamp 210 restrict the range of motion that the pivot rod 212 may rotate.

Connected with the base plate 204 is the plug 22. The distal portion of the plug 22 is positioned through an opening in the base plate 204 with the distal portion being placed adjacent the offset portion 218 of the pivot rod 212. A nut or other retaining member 222 may be screwed onto the distal portion of the plug 22 to secure the plug 22 to the base plate 204. The leaf spring 208 is attached to the base plate and positioned adjacent the push rod 116 for selectively contacting the push rod 116. The leaf spring 208 may be generally V-shaped having two portions. One portion of the leaf spring 208 may be connected with the base plate 204. For example, one portion may include an opening which is placed over the distal portion of the plug 24. When the nut 222 is screwed onto the distal portion, the plug 24 and the leaf spring 208 are connected with the base plate 204.

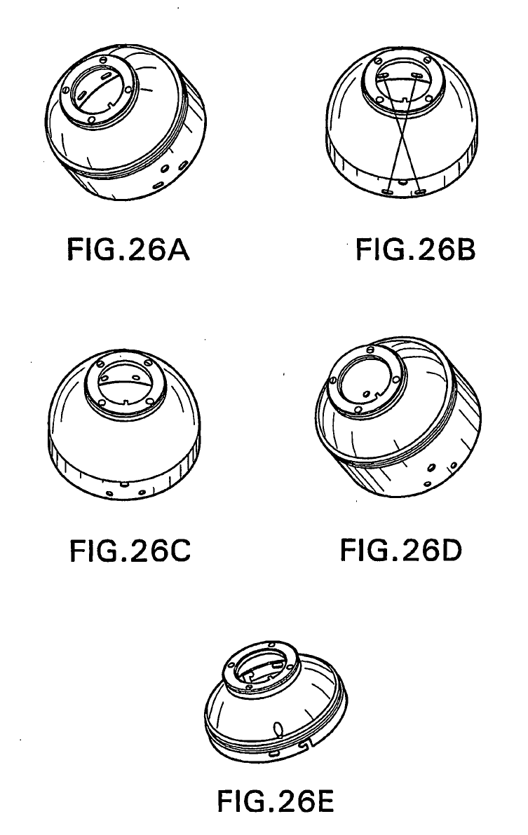

The other portion of the V-shaped leaf spring 208 may be positioned between the push rod 116 and the offset portion 218 of the pivot rod 212. In its normal, non-deformed or non-actuated configuration, the leaf spring does not activate or press the push rod 116. However, when the pivot rod 116 is rotated, the offset portion 218 of the pivot rod 116 pushes the leaf spring into contact with the push rod 116 to thereby release the plug 22 from the socket 24. This exemplary embodiment of the latching mechanism 202 permits an electrician or other person to remove an electrical appliance from a wall, ceiling, or floor by rotating the handle 214 which is spaced away from the centerline of the appliance. This embodiment allows the appliance to be quickly connected and released when the push rod 116 is not accessible because the appliance or a cover or canopy is in the way. FIGS. 26A-26E illustrate exemplary embodiments of canopies for use with the present invention.

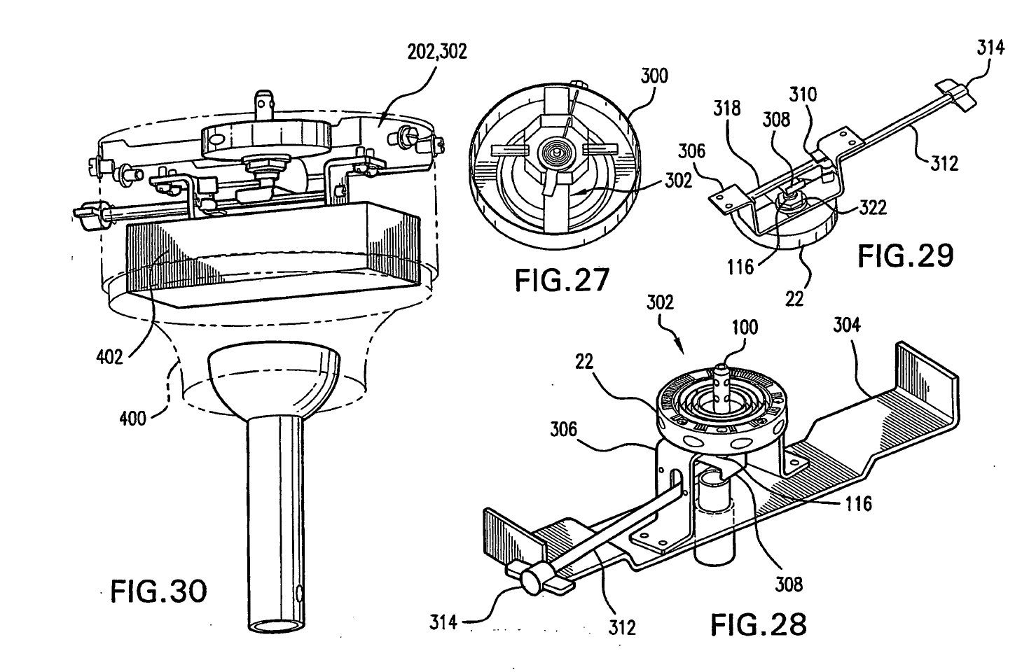

In another embodiment shown in FIGS. 27-29, an electrical assembly includes a canopy 300, a latching mechanism 302, and a quick connect device. As previously described, the latching mechanism 302 provides for the quick release of the spindle assembly 100 from the socket 24 (not shown). Moreover, the latching mechanism 302 allows the plug 22 to be released from the socket 24 when access to the push rod 116 is restricted. Generally, the latching mechanism 302 includes a base plate 304, an adapter 306, a leaf spring 308, a clamp 310, a pivot rod 312, and a handle 314.

Unlike the previously described embodiment, in the embodiment of FIGS. 27-29, the distal portion of the plug 22 is positioned through an opening in the adapter 306 and is secured with a nut 322. One portion of the V-shaped leaf spring 308 may be placed between the nut 322 and adapter 306. As described above, the pivot rod 312 is slideably and rotatably placed within two apertures of the adapter 306. Also, the clamp 310 is connected to the adapter 306 to limit the range of rotation of the offset portion 318 of the pivot rod 312. The handle 314 may be connected with the proximal end of the pivot rod 312. The base plate 304 may be attached to two feet of the adapter 306. Operation of the present embodiment is similar to the above described operation. As the handle 314 is rotated, the offset portion 318 of the pivot rod 312 pushes the leaf spring 308 into contact with the push rod 116 of the plug 22 to thereby release the plug 22 from the socket 24. Accordingly, this embodiment permits the release of the plug 22 when access to the push rod 116 is blocked by the electrical appliance, canopy, etc.

In a further embodiment, the quick connect device and latching mechanism may be used in combination with a canopy and a remote control. In FIG. 30, the latching mechanism 202,302 is positioned between the quick connect device and a remote control 402. The handle connected to the pivot rod extends outside the canopy 400. Rotating the handle permits the remote control 402 and appliance to be quickly and safely removed from and attached to the wall, floor, or ceiling.

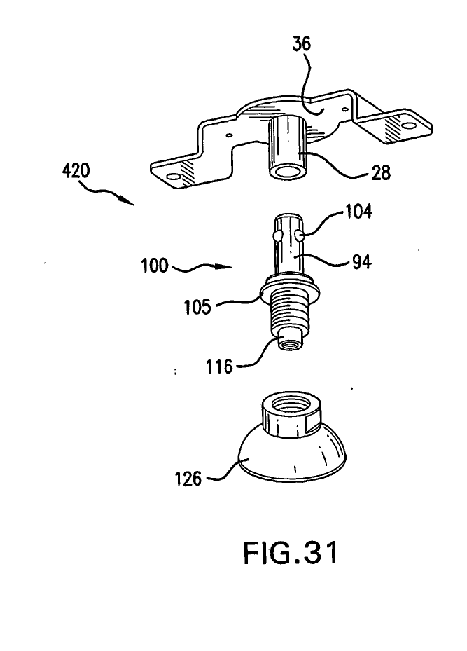

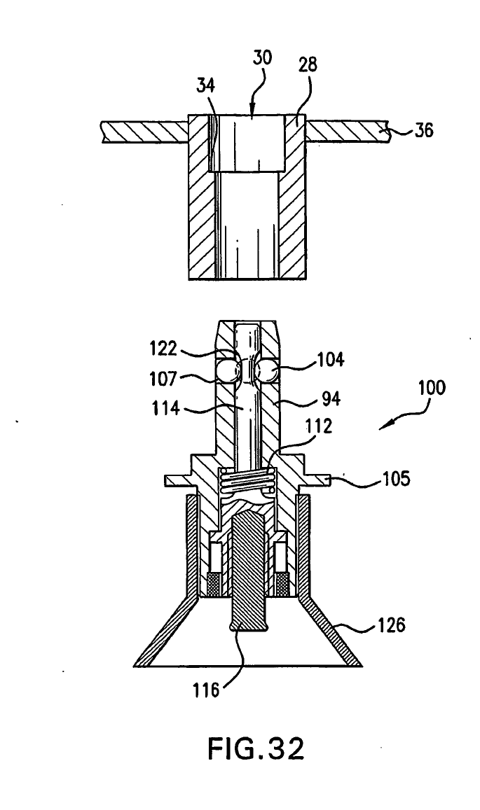

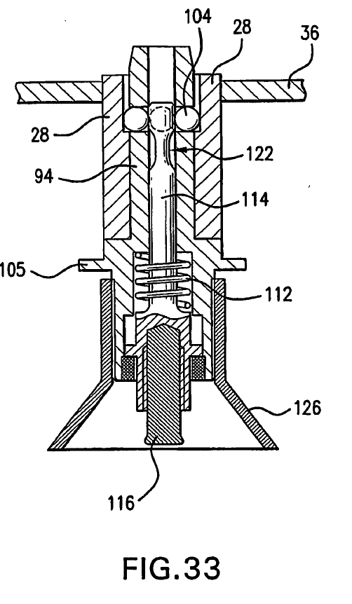

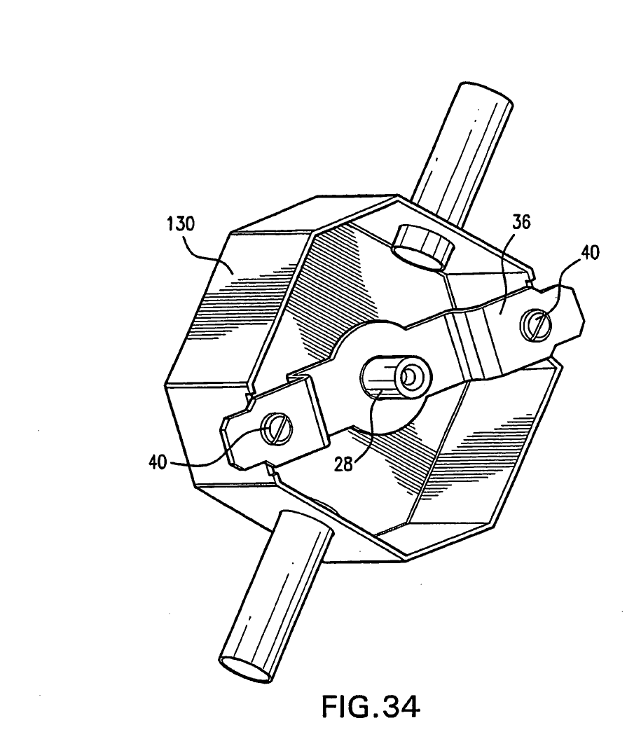

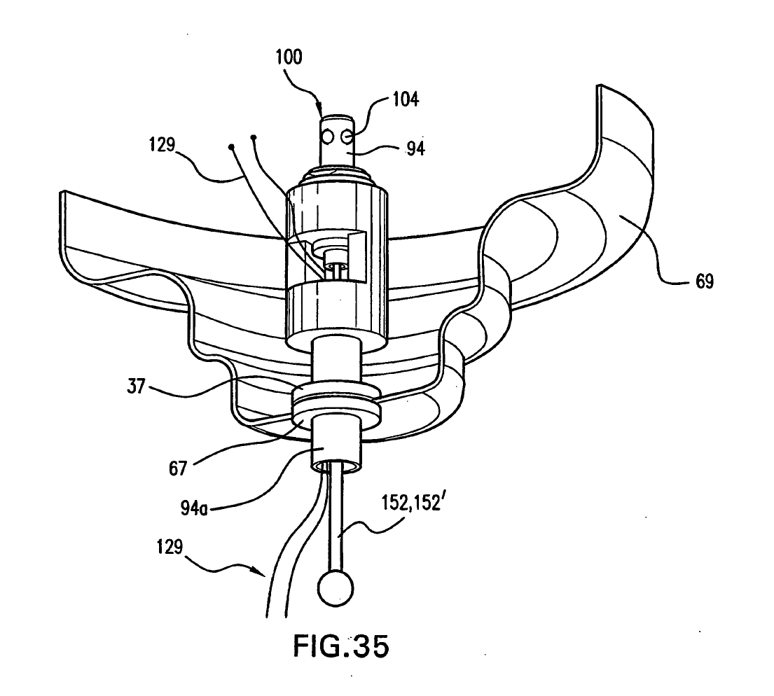

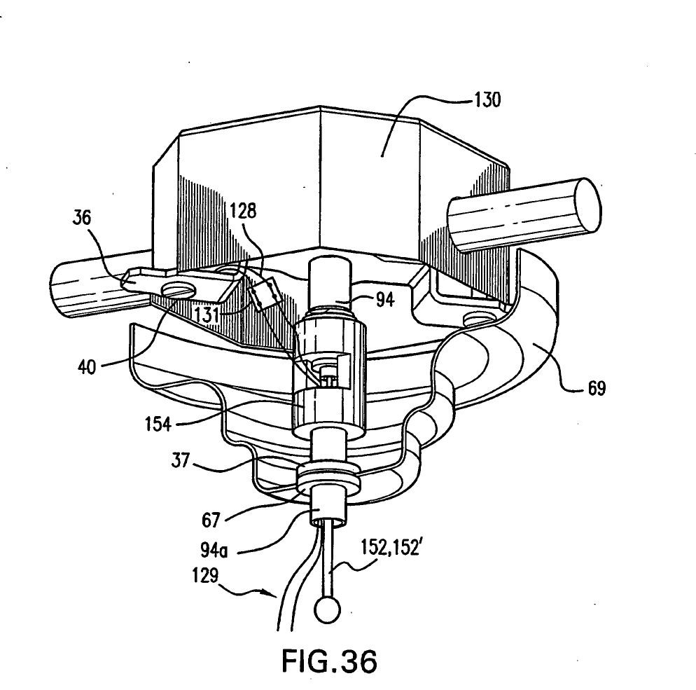

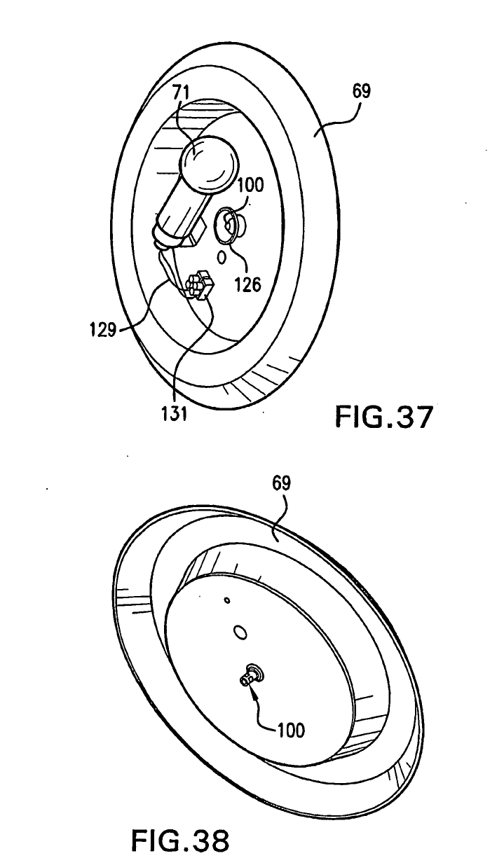

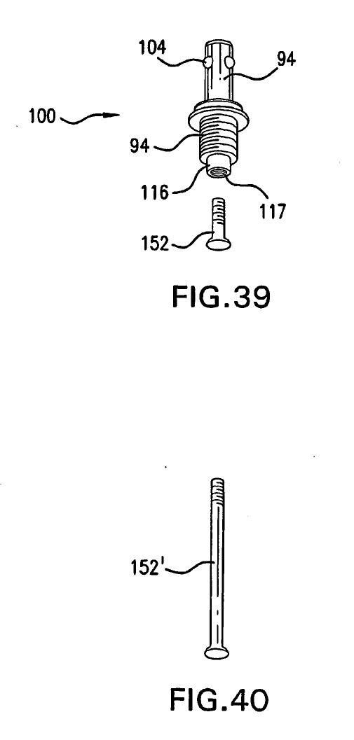

Referring to FIGS. 31-40, a quick mechanical connect device 420 for installing fixtures or the like includes the combination of a male portion in the form of a spindle assembly 100, and mating female portion in the form of a bushing 28 and mounting strap 36. The device 420 functions to establish a quick and easy mechanical connection that mechanically supports the fixture on a surface or base, typically a wall, ceiling or floor surface. As used herein, the term “fixture” means any fixture or appliance such as a lighting fixture, ceiling fan, television camera, security device or any other electrical or non-electrical device which is requires a mechanical connection to support or suspend the fixture. Spindle assembly 100 is fixedly secured to the fixture to be mounted such as a light fixture 69 having a light bulb 71 or a fan housing 75. The bushing 28 is secured to the mounting strap 36, which in the illustrated embodiment is U-shaped.

The bushing 28 includes a cylindrically shaped, essentially hollow tube having an enlarged bore 30 in one end thereof which forms an annular internal shoulder 34. The tubular bushing 28, which is preferably formed of metal, can be attached to the strap 36 by welding or can be integrally formed with the strap 36, if desired.

The mounting strap 36 is provided with apertures on its outer extremities which receive screws 40 that mount the strap 36 and thus the bushing 28 on an electrical junction box 130. The U-shaped configuration of the strap 36 allows the bushing 28 to be recessed within the junction box 130. However, in those applications where it is necessary to mount the bushing 28 directly on a wall or ceiling without use of a junction box, a flat strap may be employed.

The spindle assembly 100 includes a tubular main body or barrel 94, a plunger or pin 114 slidably disposed within the barrel 94 and a finger hold or guard cover 126 which is screwed onto the threaded lower end of the barrel 94. The upper end of the barrel 94 includes openings 107 which receive retaining balls 104. The upper end of the plunger 114 includes a reduced diameter section 122 that allows the balls 104 to shift radially inward when the reduced diameter potion 122 is aligned with the balls 104. A spring 112 captured within the barrel 94 normally urges the plunger 114 downwardly, forcing the balls 104 to move outwardly, so that the weight of the fixture is loaded onto the shoulder 34. Immobilized in the their most outward position, the balls 104 cause interference with the shoulder 34, preventing the spindle assembly 100 from withdrawing from the bushing 28, thus mechanically mounting the fixture 69 on the junction box 130, via the strap 36.

The plunger 114 is fitted with a release button 116 which is surrounded by the finger hold 126. The user may unlock (release) the device 420 by depressing the button 116. Displacement of button 116 in this manner moves the plunger 114 upwardly, until the balls 104 align with the reduced diameter portion 122 of the plunger 114, which allows the balls 104 to move inwardly, so as to clear the shoulder 34. While continuing to hold the button 116 in its depressed position, the user may then remove the spindle assembly 100 from the bushing 28 and strap 36 and disconnect the fixture 69 from the junction box 130. A long push rod 152 may be thread into the end 117 of the release button 116 to extend the button for easier access. Furthermore, the push rod 152 may be replaced by a threaded extension rod 152′ where it is necessary to operate the device 420 from a greater distance beneath the device due to fixture obstructions or the like.

The fixture 69 can be secured to the spindle assembly 100 in a variety of ways. As shown in the drawings, the barrel 94 includes a ring shaped outer flange 105. A portion of the fixture 69 can be captured between this flange 105 and a nut 67, thereby tightly securing the fixture to the spindle assembly 100 of the device 420.

The finger hold 126 not only protectively covers the sides of the push button 116 in order to prevent inadvertent actuation of the latter, but acts as a guide to lead a user's finger onto the end of the button 116. Further, the finger hold 126 provides a means of gripping and holding the spindle assembly 100 during the installation process; the user places the index and middle finger fingers on the sprayed lower portion of the hold 126 while the thumb actuates the push button 116.

As previously mentioned, the electrical fixture may be secured to the spindle assembly 100 in any of a variety of ways. For example, the fixture may be fixedly attached to the finger hold 126, or directly to the barrel 94. Alternatively, the fixture may be secured to a piece of mounting hardware, such as a “hickey” 154 threaded onto the lower end of the barrel 94. In any event, it may be appreciated that the weight of the fixture 69 transmitted through the barrel 94, retaining balls 104, and bushing 28 to the mounting strap 26, which in turn is secured to the junction box, wall or other structure on which the fixture is to mounted.

In some installations it may be necessary to effectively extend the length of the push button 116 where, for example, a motor or other parts of the electrical fixture are covered by a downwardly extending shroud or canopy (not shown). In this event, additional hardware such as the threaded hickey 154 is screwed onto the lower threaded portion of the barrel 94. A threaded guide barrel 94a is in turn screwed into the lower end of the hickey 154. An elongate push rod 152 or 152′ is utilized which is attached at its end to the plunger 114. The push rod 152 or 152′ is guided by the guide barrel 94a, with its lower end extending beyond the lower end of the guide barrel 94a.

After a fixture is installed using the device 420, electrical wiring between a supply line and the fixture may be performed in the normal manner. For example, electrical supply lines 128 fed into the junction box 130 are connected with lead wires 129 on the fixture using a connector junction 131, wire terminals or the like.

Having described details of the preferred embodiment of the device 420, and various modifications thereto, the use and operation of the device 420 will now be explained. The bushing 28 and strap 36 are first installed either on an electrical junction box 130 or directly on a wall or ceiling surface. The electrical fixture to be installed is first mounted on the spindle assembly 100. As previously discussed, the exact mounting method will vary, depending on the type, size and configuration of the fixture. Having secured the fixture to the spindle assembly 100, the installer first depresses the push button 116 to displace the plunger 114 until the depression in the sides of the plunger 114 aligns with the balls 104. The balls 104 move into the plunger depression 122, allowing the upper cylindrical section of the barrel 94 to pass into the central bore in the bushing 28. At this point, the installer releases the push button 116, whereupon spring 112 axially displaces the plunger 114 to its normal locking position, forcing the balls 104 outwardly until they engage the shoulder 34 to hold the plunger 114 in its locked position. This sequence of events is reversed when the user wishes to disconnect the fixture from the junction box 130.

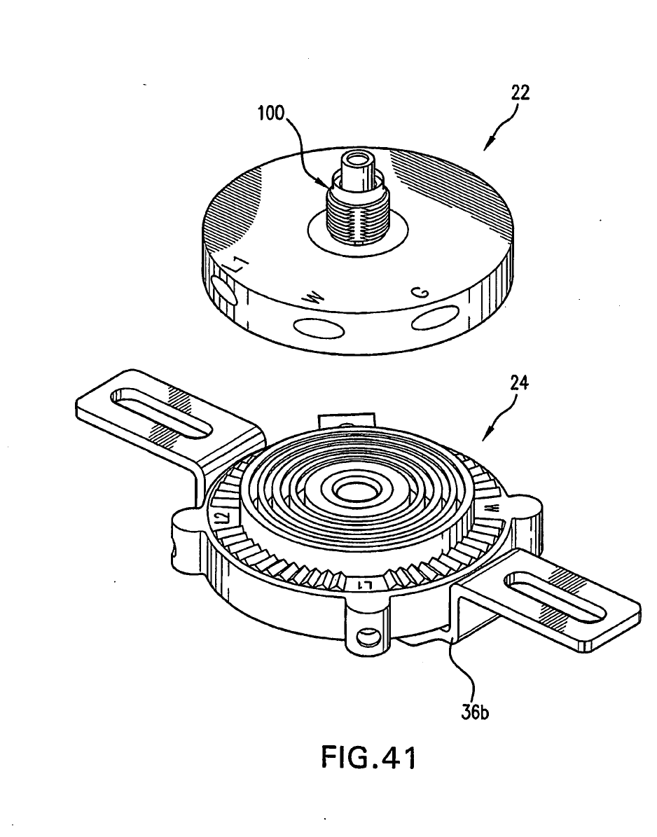

Another exemplary embodiment of the quick connect device is shown in FIG. 41. The device includes the socket 24 and mounting strap 36b, and further includes the plug 22 with the spindle assembly 100. The plug 22 is configured and dimensioned to mate with the socket 24 to form the quick connect device of the present invention. As previously described, the quick connect device can be used to attach or mount a fixture, such as a light fixture, to the ceiling or other surface.

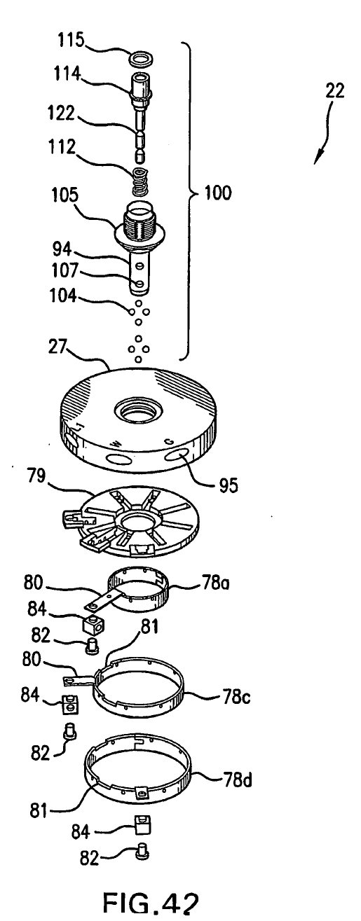

An exploded view of the plug 22 is shown in FIG. 42. The spindle assembly 100 of the plug 22 includes a barrel 94 having a longitudinal channel extending therethrough. A plunger or pin 114 is positioned within the longitudinal channel of the barrel 94 and is slidable with the channel. A spring 112 is positioned around the pin 114 and within the channel of the barrel 94 to thereby allow the pin 114 to be actuated (i.e. movable) within the channel. Disposed on the distal section of the pin is a plurality of depressions or ball detents 122. Each detent 122 is a circumferential groove in the pin 114. As illustrated, there are two ball detents 122 on the pin spaced apart from each other. The ball detents 122 are of a configuration to maintain or capture a portion of one or more retaining balls 104. The two ball detents 122 may be spaced approximately 7.5 mm from each other.

As shown in FIG. 42, four retaining balls 104 correspond to each ball detent 122, providing a total of eight retaining balls 104. The distal portion of the barrel 94 includes a plurality of radial openings 107 extending through the wall of the barrel 94. Each radial opening 107 is dimensioned and configured to maintain or capture a portion of one retaining ball 104 in such a manner to prevent the retaining ball from being able to passing completely through the radial opening 107. When the spindle assembly 100 is in an assembled state, the pin 114 is positioned within the barrel 94 with the spring 112 located between the pin 114 and barrel 94 to provide spring activation of the pin 114. The pin 114 remains in the barrel 94 with an o-ring 115. The retaining balls 104 are located within the longitudinal channel of the barrel 94 and within the radial openings 107.

In an unactuated configuration, the retaining balls 104 are pressed by the pin 114 in a radial direction forcing a portion of each ball 104 to extend out of the radial openings 107. In an actuated configuration when the pin 114 is pressed and the spring 112 is compressed, the depressions 122 on the pin 114 are aligned with the radial openings 107 of the barrel 94 allowing the retaining balls 104 to move radially inward and not extend outwardly from the radial openings 107. The spindle assembly 100 is secured to the plug body 27 by way of extensions or flanges 105.

The plug body 27 is generally cylindrical in shape, like a wheel. The plug body 27 is hollow or has a cavity on one side. In FIG. 42, the hollow portion of the plug body 27 is on the bottom side which is not shown. A plurality of lateral wire openings 95 is located on the circumference of the plug body 27. The wire openings 95 are dimensioned to receive a stripped end of an electrical wire and are therefore, preferably, configured like a cylindrical passage. The longitudinal axes of the wire openings 95 are generally perpendicular to the radius of the socket body 27 and/or generally tangential to the circumference of the socket body 27. As illustrated, there are three wire openings 95 in the socket body 27: one to receive a “hot” electrical wire, one to receive a “neutral” wire, and one to receive a “ground” wire.

Disposed within the cavity of the plug body 27 are a ring support member 79 and a plurality of connector rings 78a, 78c, and 78d. The support member 79 and rings 78 may be fastened to or molded within the socket body 27. As seen in FIG. 42, connector ring 78a is smaller in diameter than connector ring 78c which is smaller in diameter than connector ring 78d. Connector ring 78a may have a diameter of about 1.9 cm; ring 78c may have a diameter of approximately 2.9 cm; and ring 78d may have a diameter of about 3.4 cm. The connector rings 78 may include a plurality of notches 81. The notches 81 of a connector ring serve to increase the distance between the ring and adjacent rings to thereby reduce the chance of current/voltage arcing between the connector rings. For example, connector ring 78d includes two notches 81: one to increase the distance between an extension arm 80 of connector ring 78c and one to increase the distance between the extension arm 80 of connector ring 78a.

When the plug 22 is assembled, the ring support member 79 is positioned within the cavity of the plug body 27. Each connector ring 78 is positioned within the cavity of the plug body 27 with the center axes of the rings 78 being generally aligned with the center axis of the plug body 27. In this configuration, since the connector rings 78 have different diameters, the rings 78 are spaced apart from each other. The extension arms 80 of the rings 78 extend radially outward toward the outer edge portion of the plug body 27. A plurality of terminal blocks 84 is positioned in the outer edge portion of the body 27 generally adjacent to and in line with the wire openings 95. Each terminal block 84 is connected with one of the arms 80 of a ring 78 such that an electrical wire positioned in a wire opening 95 is connected with a terminal block 84 with a screw 82. For each of the connector rings 78, an electrical connection is made from a wire to a terminal block to an extension arm and to a connector ring. The plug body 27 may include three terminal blocks 84: one for the “hot” wire, one for the “neutral” wire, and one for the “ground” wire. The three terminal blocks 84 may be positioned in the plug body 27 and spaced apart about 45 degrees from each other.

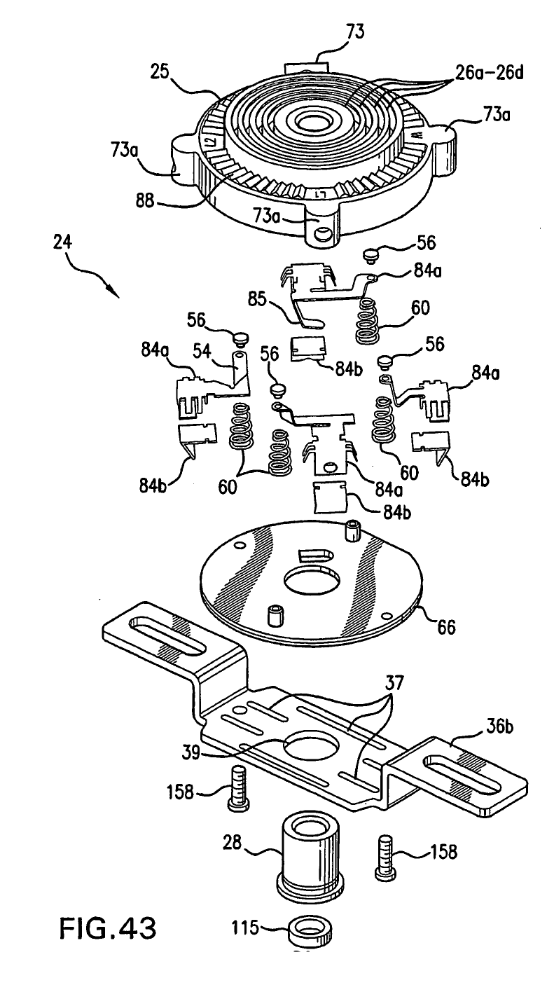

The socket 24 of the quick connector device is illustrated in FIG. 43. The socket 24 includes a socket body 25. The socket body 25 is generally cylindrical in shape like the plug body 27 and may have a diameter of about 5 cm. The socket body 25 includes central passage and a plurality of ring shaped slots 26a-26d disposed around the central passage. Each slot 26 is dimensioned and configured to receive a connector ring 78 from the plug 22. The slots 26 extend through the socket body 27 providing access to one or more cavities formed in the bottom side of the socket body 25. The cavity or cavities and bottom side are not shown in FIG. 43, but are similar to the embodiment shown in FIG. 12. The socket body 25 of FIG. 43 includes four slots 26a-26d. When a socket 24 with four slots is mated with a plug 22 with four connector rings 78, each slot receives a corresponding ring to make an electrical connection. However, when a socket 24 with four slots is mated with a plug 22 with three rings 78 as shown in FIG. 42, one of the slots of the socket will not be filled with a ring. In this configuration, ring 78a is disposed in slot 26a; ring 78c is disposed in slot 26c; and ring 78d is disposed in slot 26d to thereby form three electrical connections: hot, neutral and ground.

The socket body 25 further includes a sunken rim disposed on the same side of the body 25 as the slots 26a-26d. The rim allows the socket body 25 to be mated with the plug 22 by permitting that portion of the socket body 25 which creates the slots 26 to be positioned within the cavity of the plug body 27 and thereby positioning the connector rings 78 within the slots 26. A surface of the rim of the socket body 25 may include teeth or ridges 88. A surface of the plug body 27 may also include teeth or ridges 88 as best seen in FIG. 1. When mated, the teeth 88 of the socket body 25 and teeth 88 of the plug body 27 engage to prevent the plug 22 and socket 24 from rotating relative to each other. Each of the teeth 88 may be approximately 1 mm in height and about 2 mm in width.

Radial projections or ears 73 and 73a extend from the outer wall of the socket body 25 thereby extending the length or depth of access openings 72. The radial projections or ears 73 may have any cross-sectional shape including a rectangle, circle, triangle, square, etc. Furthermore, the ears 73 and 73a may be spaced equidistantly about the circumference of the socket body 25; for example, at 90; 180, 270, and 360 degrees. Preferably, ear 73, which holds or contains the “ground” wire, is cube shaped with an access opening extending therethrough. The other ears 73a, which contain “hot L1” and “hot L2” and “neutral”, have a half-round edge. The radial projections or ears 73 and 73a provide additional enclosure of the electrical wires positioned therein. Without an ear on the outer wall of the socket body 25, a stripped end portion of an electrical wire inserted into an access opening 72 may be exposed and create an unsafe condition. Therefore, the radial projection 73 and 73a enhances the safety of the socket 24 by covering any exposed, stripped electrical wire.

Within the cavity or cavities of socket body 25, a plurality of terminal blocks 84 are aligned with the access openings 72 and the slots 26. Each terminal block 84 provides an electrical connection between an electrical wire and slot. The terminal block 84 holds or pinches the wire between a terminal frame 84a and a spring plate 84b which are described in more detail later. Each terminal block includes a spring arm 54 and a contact member 56 positioned at the distal end of the arm. A spring 60 is positioned between each contact member 56 and a cover plate 66. The cover plate 66 is generally a flat disk dimensioned to cover the cavity or cavities of the socket body 25. The plate 66 may include a flat edge which aligns with a flat edge of the socket body 25 to limit the positioning of the cover 66 to one orientation relative to the socket body 25. The cover plate 66 may also include an opening through which a grounding strap, described in more detail later, may be positioned. When assembled, the socket completes electrical connections as follows: an electrical wire is positioned with an access opening 72 and is connected with a terminal block 84. Current travels from the wire to the terminal block 84, through the spring arm 54, and to the contact member 56. When the plug 22 is mated with the socket 24, the current continues to flow from the contact member 56, to a connector ring 78, through an extension arm 80, to a terminal block 84, and to an electrical wire connected with the terminal block 84.

To mount the socket 24 to a junction box or other structure, a mounting strap 36b is connected to the socket body 25 with screws 158. As shown in FIG. 43, the strap 36b is generally U-shaped and includes a central orifice 39. The strap 36b includes a plurality of reinforcement ridges 37 disposed on a surface thereof. The reinforcement ridges 37 increase the load bearing capacity of the strap 36b to safely install heavy fixtures and may be located on the underside and/or topside of the strap 36b. As illustrated in FIG. 43, there may be three pairs of ridges 37. A bushing 28 is positioned through the orifice 39 and fixedly attached to the mounting strap 36 by welding or by an o-ring 115. The bushing 28 is generally tubular and is positioned within the central passage of the socket body 25 and within the center of connector ring 26a. The bushing 28 also includes a channel extending therethrough. The channel is dimensioned and configured to receive the spindle assembly 100 of the plug 22 and hold the spindle assembly 100 by providing one or more shoulders on which the retaining balls 104 can engage. The features of the bushing 28 are more fully shown in FIG. 14 and described in the corresponding text. As illustrated in FIG. 14, the channel of the bushing 28 has two different diameter bores 30 and 32. Bore 30 may have a diameter of about 7.5 mm, while bore 32 may have a diameter of approximately 8 mm.

When the plug 22 and socket 24 are mated, they not only form electrical connections as previously described, but also provide a mechanical connection between the fixture and ceiling/mounting surface. For example, the fixture is attached to the spindle assembly 100; the spindle assembly 100 is firmly secured in the bushing 28; the bushing 28 is fixed to the mounting strap 36b; and the mounting strap 36b is connected to a junction box or other structure. In this configuration, the weight of the fixture is transmitted through metal components and not through the material of the socket 24 and plug 22.

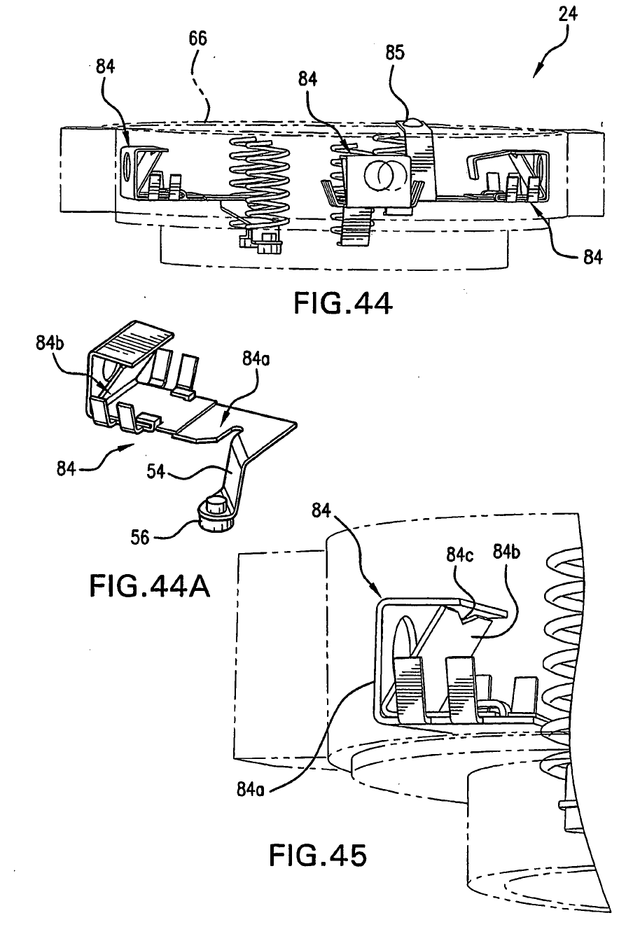

FIGS. 44, 44A, and 45 illustrate the terminal blocks 84 of the present invention. The terminal blocks 84 are positioned within the socket body 25. The terminal block 84 designed to retain the “ground” wire includes a grounding strap 85. As seen in FIG. 44, the grounding strap 85 extends from the terminal block 84 and through the cover 66 of the socket 24. When the socket 24 is connected with the mounting strap 36b, the grounding strap 85 connects the mounting strap 36b to thereby complete a grounding circuit. The grounding circuit created by the grounding strap 85 may be in addition to the grounding circuit created by the terminal block 84 and grounding wire.

The terminal frame 84a and spring plate 84b are shown in FIG. 45. The terminal frame 84a includes an orifice through which an electrical wire may be positioned. A stripped end of the electrical wire is positioned in a groove 84c formed between the terminal frame 84a and spring plate 84b. In use, an electrical wire is passed through the orifice of the terminal frame 84a and pushed into the groove 84c. The spring plate 84b is flexible such that it deflects as the wire is inserted into the groove 84c. The wire is pinched between the top portion of the terminal frame 84a and an end portion of the spring plate 84b. In this configuration, with the spring plate 84b deflected, the wire is prevented from being pulled straight out of the terminal block 84. If it is desired to intentionally pull the wire out of the terminal block 84, the above described configuration permits the wire to be twisted and pulled out of the block 84.

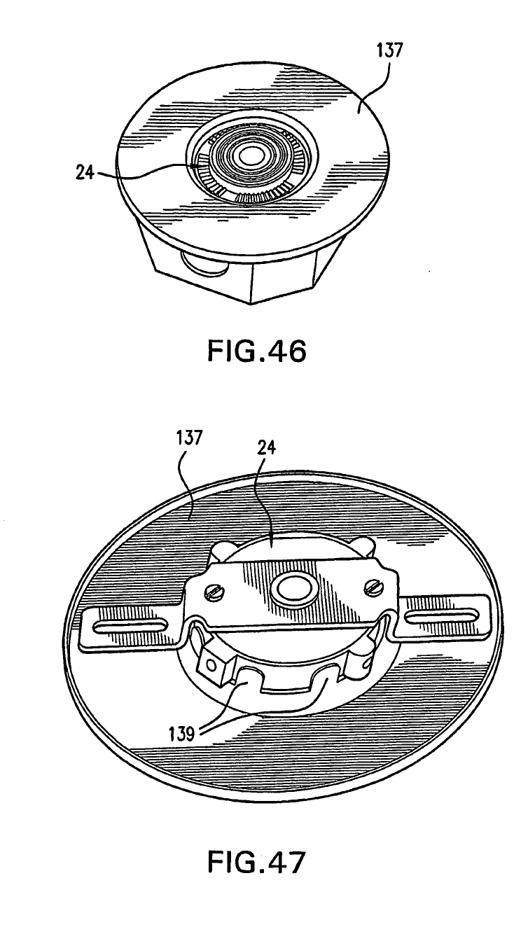

A socket skirt 137 is illustrated in FIGS. 46 and 47. The skirt 137 is generally a circular plate with an opening in the middle. The opening is dimensioned to receive the socket 24. The skirt 137 is secured to the socket 24 by a plurality of tabs 139. Tabs 139 are deflectable such that as the skirt 137 is placed about the socket 24 the tabs 139 deflect radially outward and squeeze the socket 24 to hold the skirt 137 to the socket 24. The socket skirt 137 is useful for covering up the mounting strap and other components which are not intended to be seen.

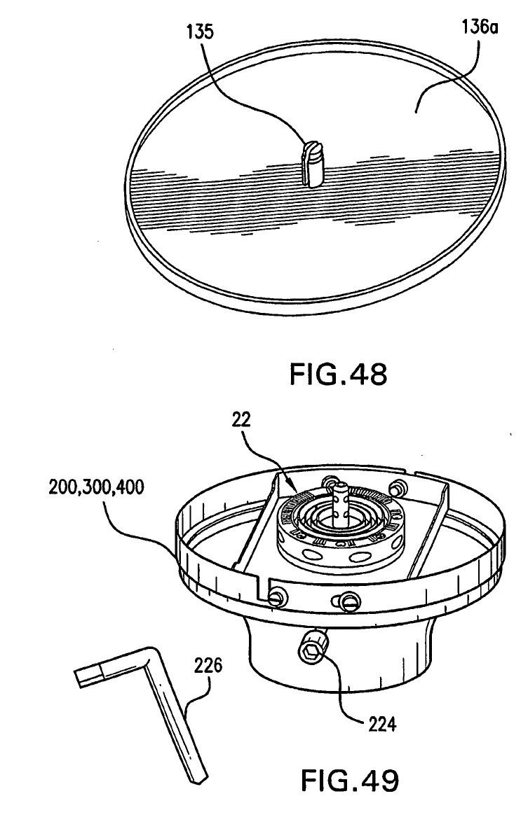

FIG. 48 illustrates a socket cover 136a which is generally a circular plate with a knob 135 at the center thereof. The knob 135 is dimensioned to be positioned in and held within the barrel 28 of the socket 24. The knob 135 may include a slit dividing the knob 135 into two portions. As the knob 135 is inserted into the barrel 94, the two portions deflect towards each other closing the slit and frictionally holding the cover 136a within the barrel 94. The socket cover 136a is useful for covering up the socket 24 and surrounding area when a plug 22 is not inserted within the socket 24.

As previously shown in FIGS. 20 and 28, latching mechanisms 202,302 allow a user to engage and disengage the plug 22 from the socket 24 when access to the plug 22 is restricted by, for example, a fixture or canopy. FIG. 49 illustrates another embodiment of activating the latching mechanism 202,302. A female receptacle 224 is connected with the latching mechanism 202,302. A male tool 226 is configured for insertion in the female receptacle 226, and thereafter, the tool 226 and receptacle 224 may be rotated to engage and disengage the plug 22 from the socket 24 in a manner previously described. In an alternative embodiment, it is contemplated that the male component may be connected with the latching mechanism 202,302 while the female component may be the tool. In either configuration, the component attached to the latching mechanism may be positioned entirely behind the canopy so as not to be seen. A cover may be removed from an opening in the canopy to gain access to the component for rotation thereby engaging and disengaging the plug 22 from the socket 24.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A device for connecting an electrical fixture with electrical power supply wiring, and for mounting the fixture on a support, comprising:
a socket including a socket body having at least one internal cavity therein;
an electrically conductive contact terminal disposed within the cavity for establishing an electrical connection between the electrical power supply wiring and the socket, the contact terminal having a portion thereof captured between internal surfaces of the socket body to hold the contact terminal in a fixed position without the need for fasteners;
a plug rigidly fixed to the fixture and insertable into the socket, the plug having at least one male connector electrically connected to the fixture and engageable with the contact terminal within the socket to establish a circuit between the electrical fixture and the electrical power wiring; and,
a releasable latch carried on the combination of the plug and the socket for releasably mounting the fixture on the support.

2. The device of claim 1, wherein the socket includes a cover on the socket body overlying the cavity and engaging the contact terminal portion.

3. The device of claim 1, wherein the socket body includes a ledge within the cavity, and medial portions of the contact terminal are supported by the ledge.

4. The device of claim 1, including a spring member seated within the cavity for biasing the contact terminal toward the male connector to assure positive electrical contact with the male connector.

5. The device of claim 4, wherein the socket includes a cover on the socket body overlying the cavity, and the spring is a compression spring captured between one end of the contact terminal and the cover.

6. The device of claim 1, wherein the contact terminal includes a flexible leg engageable with and displaceable by the male connector.

7. The device of claim 1, wherein the contact terminal includes an upper extremity provided with a pair of closely space legs defining a slot within which an end of the electrical power supply wiring may be inserted and frictionally captured.

8. The device of claim 1, wherein the contact terminal includes an upper extremity provided with a pair of closely space legs defining a first and second, angularly offset slots within either of which an end of the electrical power supply wiring may be inserted and frictionally captured.

9. The device of claim 8, wherein the socket includes first and second openings therein through either of which the supply wiring may be passed for connection to the contact terminal.

10. The device of claim 1, wherein the contact terminal includes a pair of spaced apart, lateral walls engaging internal surface areas of the socket body within the cavity, the lateral walls functioning to restrain the contact terminal against lateral movement within the cavity.

11. The device of claim 1, including:
a plurality of spaced apart cavities in the socket body,
a plurality of contact terminals respectively associated with and fixed within the cavities without the need for fasteners, and,
a plurality of male connectors on the plug for respectively engaging and making electrical contact with the contact terminals.

12. A device for connecting an electrical fixture with electrical power supply wiring, and for mounting the fixture on a support, comprising:
a socket including a socket body having a plurality of separated internal cavities therein;
a plurality of electrically conductive contact terminals respectively disposed within the cavities for establishing electrical connections between the power supply wiring and the socket, the contact terminals each having a flexible contact portion;
a plug rigidly fixed to the fixture and insertable into the socket, the plug having a plurality of male connectors electrically connected to the fixture and respectively engageable with the contact terminals within the socket to establish a circuit between the electrical fixture and the electrical power supply wiring;
a plurality of spring members respectively mounted within the socket body cavities for biasing the flexible contact portions into engagement with the corresponding male connectors, and,
a releasable latch carried on the combination of the plug and the socket for releasably mounting the fixture on the support.

13. The device of claim 12, wherein each of the spring members is a compression spring.

14. The device of claim 13, wherein:
the socket includes a cover secured to the socket body and overlying the cavities, and
each of the compression springs is trapped between the cover and a corresponding one of the flexible contact portions.

15. The device of claim 14, wherein each of the flexible contact portions includes a spring retainer on an extremity thereof for retaining one end of the compression spring.

16. The device of claim 15, wherein the cover includes a plurality of spring retaining elements formed on the inside thereof for retaining the other end of the compression springs.

17. The device of claim 15, wherein the spring retainer passes through the flexible contact portion and includes a contact member engageable with a corresponding one of the male connectors.

18. The device of claim 12, wherein each of the contact terminals having a portion thereof captured between internal surfaces of the socket body to hold the contact terminal in a fixed position without the need for fasteners.

19. The device of claim 12, wherein the socket body includes a ledge within each of the cavities, and medial portions of each of the corresponding contact terminals are supported by the ledge.

20. A device for connecting an electrical fixture with electrical power supply wiring, and for mounting the fixture on a support, comprising:
a socket including a socket body having at least one internal cavity therein, and having first and second ends connected by a side wall;
an electrically conductive contact terminal disposed within the cavity for establishing an electrical connection between the power supply wiring and the socket;
a plug rigidly fixed to the fixture and insertable into second end of the socket, the plug having at least one male connector electrically connected to the fixture and engageable with the contact terminal within the socket to establish a circuit between the electrical fixture and the electrical power supply wiring;
at least one access opening in the first end of the socket communicating with the cavity, the access opening allowing the power supply wiring to be inserted therethrough into the cavity and connected with the contact terminal; and,
a releasable latch carried on the combination of the plug and the socket for releasably mounting the fixture on the support.

21. The device of claim 20, including at least a second access opening in the sidewall of the socket body for allowing the power supply wiring to be inserted therethrough into the cavity and connected with the contact terminal.

22. The device of claim 20, wherein the contact terminal includes at least a first slot therein facing the first access opening for receiving and gripping the end of the power supply wiring.

23. The device of claim 22, wherein the contact terminal includes a second slot therein facing the second access opening for receiving and gripping the end of the power supply wiring.

24. The device of claim 20, wherein the socket includes a cover on the first end of the socket body overlying the cavity, and the first access opening is formed in the cover.

25. The device of claim 23, wherein the contact terminal is of unitary construction and includes a bifurcated end defining the first and second slots.

26. A device for connecting an electrical fixture with electrical power supply wiring, and for mounting the fixture on a support, comprising:
a socket;
an electrically conductive contact terminal disposed within the socket for establishing an electrical connection between the power supply wiring and the socket, the contact terminal having first and second angularly offset slots therein for receiving and gripping an end of the power supply wiring, the first and second slots providing choices for inserting the power supply wiring into the socket from either of two different locations on the socket;
a plug rigidly fixed to the fixture and insertable into the socket, the plug having at least one male connector electrically connected to the fixture and engageable with the contact terminal within the socket to establish a circuit between the electrical fixture and the electrical power supply wiring; and,
a releasable latch carried on the combination of the plug and the socket for releasably mounting the fixture on the support.

27. The device of claim 26, wherein the socket includes at least one cavity therein and the contact terminal is disposed within the cavity.

28. The device of claim 27, wherein the socket includes a ledge within the cavity, and medial portions of the contact terminal are supported by the ledge.

29. The device of claim 27, including a spring member seated within the cavity for biasing the contact terminal toward the male connector to assure positive electrical contact with the male connector.

30. The device of claim 26, wherein the socket includes:
an end wall;
a side wall; and,
first and second wire access openings respectively in the end wall and the side wall, the first and second wire access openings being aligned with the first and second slots respectively, and allowing an end of the power supply wiring to passed therethrough and inserted to the corresponding slot.

31. Apparatus for providing an electrical fixture connection on a flat surface such as a wall or ceiling, comprising:
a socket recessed into the surface and having a cylindrically shaped body; and
a cover for covering the socket when a fixture is not installed on the socket, the cover including a ring shaped portion which may be sleeved over the cylindrical outside wall of the socket and in tight frictional engagement therewith so as to removably mount the cover on the socket, the cover extending laterally from, the socket and visually covering the socket from view.

32. The apparatus of claim 31, wherein the cover includes a raised peripheral edge on one side thereof engaging the flat surface.

33. The apparatus of claim 31, wherein the cover is essentially flat.

34. The apparatus of claim 31, wherein the cover is of one, unitary construction.

35. A device for connecting an electrical fixture with electrical power supply wiring, and for mounting the fixture on a flat wall or ceiling, comprising:
a cylindrical socket having first and second ends connected by a cylindrical sidewall;
electrically conductive contact terminals within the socket for establishing an electrical connection between the power supply wiring and the socket;
a plug rigidly fixed to the fixture and insertable into the socket, the plug having male connectors electrically connected to the fixture and engageable with the contact terminals within the socket to establish a circuit between the electrical fixture and the electrical supply wiring; and,
an assembly for mounting the socket on wall or ceiling, including a flat plate secured to the first side of the socket, and a fastener passing through the socket and the plate for fastening the socket to the wall or ceiling, the plate being essentially completely concealed behind the socket and hidden from view when the socket is mounted on the wall or ceiling.

36. The device of claim 35, wherein the plate is secured to the first side of the socket by screws.

37. A device for connecting an electrical fixture with electrical power supply wiring, and for mounting the fixture on a support, comprising:
a socket connected with the power supply wiring;
a plug rigidly fixed to the fixture and insertable into the socket, the plug having a male connector for establishing an electrical connection between the fixture and the socket;
a releasable latch centrally located on the combination of the plug and the socket for releasably mounting the fixture on the support, the latch including a central push rod for latching and releasing the latch; and,
an actuator assembly for controlling the operation of the push rod from location laterally spaced from the central axis of the push rod.

38. The device of claim 37, wherein the actuator assembly includes:
an extension lever secured to and extending laterally from the push rod, and
a mounting assembly for mounting extension the lever on the combination of the latch and the plug.

39. The device of claim 38, wherein the mounting assembly includes:
a laterally extending support member carried on the combination of the latch and the plug,
a spacer for spacing the extension lever from the support member, and,
an extension rod secured to and extending outwardly from one end of the extension lever,
wherein displacement of the extension rod moves the extension lever to shift the push rod between latching and released positions.

40. The device of claim 39, wherein the extension lever is flexible about its other end.
